(19) United States
(12) Patent Application Publication
(10) Pub. No.: US 2010/0093944 A1
(43) Pub. Date: Apr. 15, 2010

(54) CATALYST SYSTEMS AND THEIR USE FOR METATHESIS REACTIONS

(75) Inventors: Julia Marie Müller, Blaustein (DE); Oskar Nuyken, München (DE); Werner Obrecht, Moers (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/497,002

(22) Filed: Jul. 2, 2009

(30) Foreign Application Priority Data
Jul. 8, 2008 (EP) 08159922.7

(51) Int. Cl. C08F 236/14; B01J 31/02

(52) U.S. Cl. 525/328.3; 502/155

(57) ABSTRACT

Novel catalyst systems for metathesis reactions, in particular for the metathesis of nitrile rubber, which contain a specific addition of boric acid compounds.

### FIELD OF THE INVENTION

The present invention relates to catalyst systems and their use for catalysis of metathesis reactions, in particular a process for reducing the molecular weight of nitrile rubber by metathesis using these catalyst systems.

### BACKGROUND OF THE INVENTION

Metathesis reactions are used widely in chemical syntheses, e.g. in the form of ring-closing metatheses (RCM), cross metatheses (CM), ring-opening metatheses (ROM), ring-opening metathesis polymerizations (ROMP), cyclic diene metathesis polymerizations (ADMET), self-metathesis, reaction of alkenes with alkynes (enyne reactions), polymerization of alkynes and olefinization of carbonyls (WO-A-97/06185 and Platinum Metals Rev., 2005, 49(3), 123-137). Metathesis reactions are employed, for example, for the synthesis of olefins, for ring-opening polymerization of norbornene derivatives, for the depolymerization of unsaturated polymers and for the synthesis of telechelic polymers.

Metathesis catalysts are known, inter alia, from WO-A-96/04289 and WO-A-97/06185. They have the following in-principle structure:

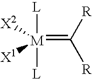

where M is osmium or ruthenium, the radicals R are identical or different organic radicals having a great structural variety, X¹ and X² are anionic ligands and the ligands L are uncharged electron-donors. In the literature, the term “anionic ligands” in the context of such metathesis catalysts always refers to ligands which, when they are viewed separately from the metal centre, are negatively charged for a closed electron shell.

Recently, metathesis reactions have become increasingly important for the degradation of nitrile rubbers.

For the purposes of the present invention, a nitrile rubber, referred to as “NBR” for short, is a nitrile rubber which is a copolymer or terpolymer of at least one α,β-unsaturated nitrile, at least one conjugated diene and, if appropriate, one or more further copolymerizable monomers.

Hydrogenated nitrile rubber, referred to as “HNBR” for short, is produced by hydrogenation of nitrile rubber. Accordingly, the C═C double bonds of the copolymerized diene units in HNBR are completely or partly hydrogenated. The degree of hydrogenation of the copolymerized diene units is usually in the range from 50 to 100%.

Hydrogenated nitrile rubber is a specialty rubber which displays very good heat resistance, excellent resistance to ozone and chemicals and excellent oil resistance.

The abovementioned physical and chemical properties of HNBR are combined with very good mechanical properties, in particular a high abrasion resistance. For this reason, HNBR has found widespread use in a wide variety of applications. HNBR is used, for example, for seals, hoses, belts and damping elements in the automobile sector, also for stators, oil well seals and valve seals in the field of crude oil production and also for numerous parts in the aircraft industry, the electronics industry, machine construction and shipbuilding.

Most HNBR grades which are commercially available on the market usually have a Mooney viscosity (ML 1+4 at 100° C.) in the range from 55 to 120, which corresponds to a number average molecular weight Mₙ, (determination method: gel permeation chromatography (GPC) against polystyrene standards) in the range from about 200 000 to 700 000. The polydispersity indices PDI measured (PDI=M_{w}/Mₙ, where M_{w}, is the weight average molecular weight and Mₙ is the number average molecular weight), which give information about the width of the molecular weight distribution, are frequently 3 or above. The residual double bond content is usually in the range from 1 to 18% (determined by means of NMR or IR spectroscopy). However, it is customary in the art to refer to “fully hydrogenated grades” when the residual double bond content is not more than about 0.9%.

The processability of HNBR grades having the abovementioned relatively high Mooney viscosities are subject to restrictions. For many applications HNBR grades which have a lower molecular weight and thus a lower Mooney viscosity are desirable since this significantly improves the processability. Many attempts have been made in the past to shorten the chain length of HNBR by degradation. For example, a decrease in the molecular weight can be achieved by thermomechanical treatment (mastication), e.g. on a roll mill or in a screw apparatus (EP-A-0 419 952). However, this thermomechanical degradation has the disadvantage that function groups such as hydroxyl, keto, carboxylic acid and carboxylic ester groups are introduced into the molecule by partial oxidation and, in addition, the microstructure of the polymer is altered substantially.

For a long time, it has not been possible to produce HNBR having a low molar mass corresponding to a Mooney viscosity (ML 1+4 at 100° C.) in the range below 55 or a number average molecular weight of about Mₙ<200 000 g/mol by means of established production processes since, firstly, a step increase in the Mooney viscosity occurs in the hydrogenation of NBR and secondly the molar mass of the NBR feedstock to be used for the hydrogenation cannot be reduced at will since otherwise work-up in the industrial plants available is no longer possible because the rubber is too sticky. The lowest Mooney viscosity of an NBR feedstock which can be worked up without difficulties in an established industrial plant is about 30 Mooney units (ML 1+4 at 100° C.). The Mooney viscosity of the hydrogenated nitrile rubber obtained using such an NBR feedstock is in the order of 55 Mooney units (ML 1+4 at 100° C.). The Mooney viscosity is determined in accordance with ASTM standard D 1646.

In the more recent prior art, this problem is solved by reducing the molecular weight of the nitrile rubber before hydrogenation by degradation to a Mooney viscosity (ML 1+4 at 100° C.) of less than 30 Mooney units or a number average molecular weight of Mₙ<70 000 g/mol. The reduction in the molecular weight is achieved by metathesis in which low molecular weight 1-olefins are usually added. The metathesis of nitrile rubber is described, for example, in WO-A-02/100905, WO-A-02/100941 and WO-A-03/002613. The metathesis reaction is advantageously carried out in the same solvent as the hydrogenation reaction so that the degraded nitrile rubber does not have to be isolated from the solvent after the degradation reaction is complete before it is subjected to the subsequent hydrogenation. The metathesis degradation reaction is catalyzed using metathesis catalysts which are tolerant to polar groups, in particular nitrile groups.

WO-A-02/100905 and WO-A-02/100941 describe a process comprising the degradation of nitrile rubber starting polymers by olefin metathesis and subsequent hydrogenation to give HNBR having a low Mooney viscosity. Here, a nitrile rubber is reacted in the presence of a coolefin and specific complex catalysts based on osmium, ruthenium, molybdenum or tungsten in a first step and hydrogenated in a second step. In this way, it is possible to obtain hydrogenated nitrile rubbers having a weight average molecular weight (M_{w}) in the range from 30 000 to 250 000, a Mooney viscosity (ML 1+4 at 100° C.) in the range from 3 to 50 and a polydispersity index PDI of less than 2.5.

The metathesis of nitrile rubber can, for example, be carried using the catalyst bis(tricyclohexylphosphine)benzylideneruthenium dichloride shown below.

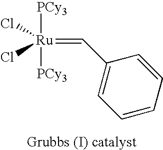

As a result of metathesis and hydrogenation, the nitrile rubbers have a lower molecular weight and a narrower molecular weight distribution than the hydrogenated nitrile rubbers which have hitherto been able to be produced according to the prior art.

However, the amounts of Grubbs (I) catalyst employed for carrying out the metathesis are large. In the experiments in WO-A-03/002613, they are for example, 307 ppm and 61 ppm of Ru based on the nitrile rubber used. The reaction times necessary are also long and the molecular weights after degradation are still relatively high (see Example 3 of WO-A-03/002613 where M_{w}=180 000 g/mol and Mₙ=71 000 g/mol).

US 2004/0127647 A1 describes blends based on low molecular weight HNBR rubbers having a bimodal or multimodal molecular weight distribution and also vulcanizates of these rubbers. According to the examples, 0.5 phr of Grubbs (I) catalyst is used for carrying out the metathesis. This corresponds to an amount of 614 ppm of ruthenium based on the nitrile rubber used.

Furthermore, a group of catalysts referred to by those skilled in the art as “Grubbs (II) catalysts” is known from WO-A-00/71554.

If a “Grubbs (H) catalyst” of this type, e.g. the catalyst 1,3-bis(2,4,6-trimethylphenyl)-2-imidazolidenylidene)(tricyclohexylphosphine)(phenylmethylene)ruthenium dichloride shown below, is used for the metathesis of NBR (US-A-2004/0132891), this is successful even without use of a coolefin.

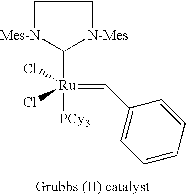

After the subsequent hydrogenation, which is preferably carried out in the same solvent, the hydrogenated nitrile rubber has lower molecular weights and a narrower molecular weight distribution (PDI) than when catalysts of the Grubbs (I) type are used. In terms of the molecular weight and the molecular weight distribution, the metathetic degradation using catalysts of the Grubbs (II) type proceeds more efficiently than when catalysts of the Grubbs (I) type are used. However, the amounts of ruthenium necessary for this efficient metathetic degradation are still relatively high. Even when the metathesis is carried out using the Grubbs (II) catalyst, long reaction times are still required.

In all the abovementioned processes for the metathetic degradation of nitrile rubber, relatively large amounts of catalyst have to be used and long reaction times are required to produce the desired low molecular weight nitrile rubbers by means of metathesis.

Even in other types of metathesis reactions, the activity of the catalysts used is of critical importance.

In J. Am. Chem. Soc. 1997, 119, 3887-3897, it is stated that in the ring-closing metathesis of diethyl diallylmalonate show below

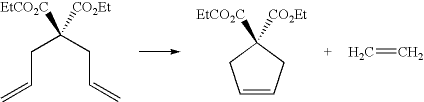

the activity of the catalysts of the Grubbs (I) type can be increased by additions of CuCl and CuCl₂. This increase in activity is explained by a shift in the dissociation equilibrium due to a phosphane ligand which leaves its coordination position being scavenged by copper ions to form copper-phosphane complexes.

However, this increase in activity brought about by copper salts in the abovementioned ring-closing metathesis cannot be applied at will to other types of metathesis reactions. Studies by the inventors have shown that, unexpectedly, although the addition of copper salts leads to an initial acceleration of the metathesis reaction in the metathetic degradation of nitrile rubbers, a significant worsening of the metathesis efficiency is observed. The molecular weights of the degraded nitrile rubbers which can be achieved in the end are substantially higher than when the metathesis reaction is carried out in the presence of the same catalyst but in the absence of the copper salts.

EP-A-1 825 913 describes new catalyst systems for metathesis, in which not only the actual metathesis catalyst but also one or more salts are used. This combination of one or more salts with the metathesis catalyst leads to an increase in the activity of the catalyst, viz. a synergistic action. Many meanings are in each case possible for the anions and cations of these salts, and these meanings can be selected from various lists. The use of lithium bromide is found, in the examples of EP-A-1 825 913, to be particularly advantageous both for the metathetic degradation of rubbers, e.g. nitrile rubbers, and for the ring-closing metathesis of diethyl diallylmalonate. Catalysts mentioned are, in particular, ones which coordinate to the metal centre of a ruthenium or osmium carbene via an oxygen-, nitrogen- or sulphur-containing substituent. Catalysts used are, for example, the Grubbs (II) catalyst, the Hoveyda catalyst, the Buchmeiser-Nuyken catalyst and the Grela catalyst.

An as yet unpublished German patent application describes specific catalyst systems for metathesis, in which not only the actual metathesis catalyst but also alkaline earth metal chlorides, preferably magnesium or calcium chloride, are added as salts.

EP-A-1 894 946 describes an increase in the activity of metathesis catalysts as a result of specific phosphane additions.

The increase in the activity of metathesis catalysts by means of salts was likewise examined in Inorganica Chimica Acta 359 (2006) 2910-2917. The influences of tin chloride, tin bromide, tin iodide, iron(II) chloride, iron(II) bromide, iron(III) chloride, cerium(III) chloride*7H₂O, ytterbium(III) chloride, antimony trichloride, gallium dichloride and aluminium trichloride on the self-metathesis of 1-octene to form 7-tetradecene and ethylene were studied. When the Grubbs (I) catalyst was used, a significant improvement in the conversion of 7-tetradecene was observed on addition of tin chloride or tin bromide (Table 1; catalyst 1). Without the addition of a salt, a conversion of 25.8% was achieved, when SnCl₂*2H₂O was added the conversion rose to 68.5% and when tin bromide was added it rose to 71.9%. Addition of tin iodide significantly reduced the conversion from 25.8% to 4.1%. However, in combination with the Grubbs (II) catalyst (Table 1; catalyst 2), all three tin salts lead to only slight improvements in conversion from 76.3% (reference experiment without addition) to 78.1% (SnCl₂), to 79.5% (SnBr₂) and 77.6% (SnI₂). When the “Phobcats” [Ru(phobCy)₂Cl₂ (=ChPh)] (Table 1; catalyst 3) is used, the conversion is reduced from 87.9% to 80.8% by addition of SnCl₂, to 81.6% by addition of SnBr₂ and to 73.9% by addition of SnI₂. When iron(II) salts are used in combination with the Grubbs (I) catalyst (Table 3; catalyst 1), the increase in conversion when iron(II) bromide is used is higher than when iron(II) chloride is used. It may be noted that regardless of the type of catalyst used, the conversion is always higher when bromides are used than when the corresponding chlorides are used.

However, the use of the tin bromide or iron(II) bromide described in Inorganica Chimica Acta 359 (2006) 2910-2917 is not an optimal solution for the preparation of nitrile rubbers because of the corrosive nature of the bromides.

In the preparation of hydrogenated nitrile rubbers, the solvent is usually removed by steam distillation after the hydrogenation. If tin salts are used as part of the catalyst system, certain amounts of these tin salts get into the wastewater which as a result has to be purified, which costs money. For this reason, the use of tin salts for increasing the activity of catalysts in the preparation of nitrile rubbers is not economically advisable.

The use of iron salts is restricted by the fact that they reduce the capacity of some ion-exchange resins which are usually used for recovering the noble metal compounds used in the hydrogenation. This likewise impairs the economics of the overall process.

Chem Bio Chem 2003, 4, 1229-1231, describes the synthesis of polymers by ring-opening metathesis polymerization (ROMP) of norbornyl oligopeptides in the presence of a ruthenium-carbene complex Cl₂(PCy₃)₂Ru=CHphenyl, with lithium chloride being added. The addition of lithium chloride is undertaken with the declared aim of avoiding aggregation and increasing the solubility of the growing polymer chains. Nothing is reported about an activity-increasing effect of the salt addition on the catalyst.

J. Org. Chem. 2003, 68, 202-2023, too, discloses carrying out a ring-opening polymerization of oligopeptide-substituted norbornenes, in which lithium chloride is added. Here too, the influence of lithium chloride as solubility-increasing additive for the peptides in nonpolar organic solvents is emphasized. For this reason, an increase in the degree of polymerization “DP” can be achieved by addition of lithium chloride.

In J. Am. Chem. Soc. 1997, 119, 3887-3897, it is stated that addition of LiBr or NaI to a metathesis catalyst containing NHC ligands, e.g the Grubbs (II) catalyst, enables the chloride ligands to be replaced by bromide or iodide. Furthermore, it is shown that the catalyst activity depends on the type of halide ligands and increases in the order: I<Br<Cl.

In J. Am. Chem. Soc. 1997, 119, 9130-9136, it is stated that the activity of the Grubbs (I) catalyst in the ring-closing metathesis of 1,ω-dienes can be increased by addition of tetraisopropoxytitanate and an improvement in yield can therefore be achieved. In the cyclization of the 9-decenoic ester of 4-pentenoate, a higher yield of the macrolide is achieved when tetraisopropanoxytitanate is added than when LiBr is added. There is no indication of the extent to which this effect can be carried over to other types of metathesis reactions or other metathesis catalysts.

In Organic. Biomol. Chem. 2005, 3, 4139-4142, the cross methathesis (CM) of acrylonitrile with itself and with other functionalized olefins when using [1,3-bis(2,6-dimethylphenyl)-4,5-dihydroimidazol-2-ylidene](C₅H₅N)₂(Cl)₂Ru=CHPh is examined. The yield of the respective product is improved by addition of tetraisopropoxytitanate. This publication gives the impression that the activity-increasing action of tetraisopropoxytitanate occurs only when using a specific catalyst having pyridine ligands. There is no reference to the influence of tetraisopropoxytitanate when using pyridine-free catalysts or in other types of metathesis reactions.

It is known from Synlett 2005, No. 4, 670-672, that the addition of tetraisopropoxytitanate in the cross metathesis of allyl carbamate with methyl acrylate has an adverse effect on the product yield when the Hoveyda catalyst is used as catalyst. Thus, the addition of tetraisopropoxytitanate reduces the product yield from 28% to 0%. An addition of dimethylaluminium chloride also reduces the yield from 28% to 20%.

In Synlett 2005, No. 4, 670-672 it is also stated that the product yield in the cross metathesis of low molecular weight olefins is improved when specific boric acid derivatives are used. Use is made of chlorocatecholborane (ArO₂BCl), dichlorophenylborane (PhBCl₂) and chlorodicyclohexylborane (Cy₂BCl). Depending on the boric acid derivative, the yield increases to very different extents. To obtain appropriate improvements in yield, addition of 10-20 mol % of the boric acid derivative based on 1 equivalent of an olefin is necessary.

In Synthesis 2000, No. 12, 1766-1773, it is stated that the yields in the ring-closing metathesis of diethyl diallylmalonate using the Grubbs I catalyst are not adversely affected by additions of boron trichloride and aluminium trichloride (Table 2). In a tandem enine metathesis/Diels-Alder reaction of N-allyl-N-3-phenylprop-2-ynyl-p-toluenesulphenamide to form 4-acyl-7-phenylhexahydroisoindole via N-tosyl-1-(1-phenylvinyl)-2,4-dihydro-2H-pyrrole (as intermediate in the enine metathesis), too, the yield is not influenced by whether BCl₃ is added immediately at the beginning at the same time as the Grubbs I catalyst when the reaction is carried out as a one-pot reaction or else is added only in the second step of the Diels-Alder reaction in the case of a sequential procedure. It is shown by means of these experiments that the activity of the Grubbs I catalyst is not reduced by addition of boron trichloride or aluminium chloride. However, there is no evidence that the catalyst activity is improved by addition of boron trichloride or aluminium trichloride.

Since the metathesis reaction is enjoying increasing popularity both in the field of low molecular weight chemistry and for polymers such as nitrile rubbers, there is, despite the existing prior art, an unchanged need for improved catalyst systems for metathesis reactions and in particular for decreasing the molecular weight of nitrile rubber by metathesis. This applies all the more in view of the fact that simple transferability of results from one metathesis reaction to another cannot readily be deduced from the available prior art.

### SUMMARY OF THE INVENTION

In view of this prior art, it is an object of the present invention to provide novel catalyst systems which can be used universally in various types of metathesis reactions, lead, on the basis of a variety of metathesis catalysts, to increases in activity and thus allow a reduction in the amount of catalyst and therefore, in particular, the amount of noble metal present therein. It is an object to find, especially for the metathetic degradation of nitrile rubber, possibilities which enable the activity of the catalyst used to be increased without gelling of the nitrile rubber.

It has surprisingly been found that the activity of metathesis catalysts can be significantly increased when they are used in combination with boric esters. In particular, it has been found that the reduction of the molecular weight of nitrile rubber by metathesis can also be significantly improved when the metathesis catalyst is used as a system in combination with such boric esters. This combination increases the reaction rate of metathesis reactions and, particularly in the case of the NBR metathesis, it is possible to obtain significantly narrower molecular weight distributions and lower molecular weights without gelling occurring. At the same time, the amount of metathesis catalyst can be reduced as a result of the addition of boric esters.

### DETAILED DESCRIPTION OF THE INVENTION

The invention accordingly provides a catalyst system comprising a metathesis catalyst which is a complex catalyst based on a metal of transition group 6 or 8 of the Periodic Table and has at least one ligand bound in a carbene-like fashion to the metal and also at least one compound of the general formula (Z)

B(OR′)₃ (Z)

where
the radicals R′ are identical or different and are alkyl, cycloalkyl, alkenyl, allyl, alkynyl, aryl or heteroaryl radicals, where the heteroaryl radicals have at least one heteroatom, preferably nitrogen or oxygen, or R′ is a radical of the general formula (—CHZ¹—CHZ¹-A²-)ₚ—CH₂—CH₃, where p is an integer from 1 to 10, the radicals Z¹ are identical or different and are each hydrogen or methyl, with the radicals Z¹ located on adjacent carbon atoms preferably being different, and A² is oxygen, sulphur or —NH, or else two or three radicals R′ can be bridged to one another.

The radicals R′ in the catalyst system of the invention can also be substituted by one or more substituents. These substituents can be halogen, preferably chlorine or fluorine, alkyl, cycloalkyl, alkenyl, allyl, alkynyl or aryl radicals. The radicals R′ are particularly preferably partially or fully substituted by fluorine or chlorine radicals. As an alternative, the cycloalkyl, alkenyl, allyl, alkynyl or aryl radicals are preferably substituted by one or more alkyl radicals.

In a preferred embodiment of the catalyst system of the invention, use is made of compounds of the general formula (Z) in which the radicals R′ are identical or different and are each straight-chain or branched C₁-C₃₀-alkyl, preferably C₁-C₂₀-alkyl, particularly preferably C₁-C₁₂-alkyl, C₃-C₂₀-cycloalkyl, preferably C₃-C₁₀-cycloalkyl, particularly preferably C₅-C₈-cycloalkyl, C₂-C₂₀-alkenyl, preferably C₂-C₁₈-alkenyl, C₂-C₂₀-alkynyl, preferably C₂-C₁₈-alkynyl, C₆-C₂₄-aryl, preferably C₆-C₁₄-aryl, or C₄-C₂₃-heteroaryl, where these heteroaryl radicals have at least 1 heteroatom, preferably nitrogen or oxygen, or a radical of the general formula (—CHZ¹—CHZ¹-A²-)ₚ—CH₂—CH₃, where p is an integer from 1 to 10, the radicals Z¹ are identical or different and are each hydrogen or methyl, with the radicals Z¹ located on adjacent carbon atoms preferably being different, and A² is oxygen, sulphur or —NH.

In a particularly preferred embodiment of the catalyst system of the invention, use is made of compounds of the general formula (Z) in which the radicals R′ are identical or different and are each methyl, ethyl, n-propyl, i-propyl, n-butyl, i-butyl, tert-butyl, n-pentyl, i-pentyl, tert-pentyl, hexyl, octyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, 1-oleyl, phenyl, benzyl, o-tolyl or sterically hindered phenyl.

In particular, the radicals R′ in the formula (Z) are identical and are each methyl, ethyl, n-propyl, i-propyl, n-butyl, i-butyl, tert-butyl, n-pentyl, i-pentyl, tert-pentyl, hexyl, octyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, 1-oleyl, phenyl, benzyl, o-tolyl or sterically hindered phenyl.

Very particular preference is given to triisopropyl borate.

For the purposes of the present patent application and invention, all general or preferred definitions of radicals, parameters or explanations mentioned above and in the following can be combined with one another, i.e. between the respective ranges and preferred ranges, in any desired way.

The term “substituted” used for the purposes of the present patent application in connection with the various types of metathesis catalysts or compounds of the general formula (Z) means that a hydrogen atom on the radical or atom indicated has been replaced by one of the groups indicated in each case, with the proviso that the valency of the indicated atom is not exceeded and the substitution leads to a stable compound.

The metathesis catalysts to be used according to the invention are complex catalysts based on molybdenum, osmium or ruthenium. These complex catalysts have the common structural feature that they have at least one ligand which is bound in a carbene-like fashion to the metal. In a preferred embodiment, the complex catalyst has two carbene ligands, i.e. two ligands which are bound in a carbene-like fashion to the central metal of the complex.

Suitable catalyst systems according to the invention are, for example, systems which comprise, in addition to at least one compound of the general formula (Z), a catalyst of the general formula (A),

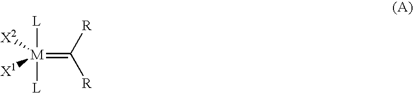

where
M is osmium or ruthenium,
X¹ and X² are identical or different and are two ligands, preferably anionic ligands,
the symbols L represent identical or different ligands, preferably uncharged electron donors,
the radicals R are identical or different and are each hydrogen, alkyl, preferably C₁-C₃₀-alkyl, cycloalkyl, preferably C₃-C₂₀-cycloalkyl, alkenyl, preferably C₂-C₂₀-alkenyl, alkynyl, preferably C₂-C₂₀-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₇₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, or alkylsulphinyl, preferably C₁-C₂₀-alkylsulphinyl, where these radicals may in each case optionally be substituted by one or more alkyl, halogen, alkoxy, aryl or heteroaryl radicals or, as an alternative, the two radicals R together with the common carbon atom to which they are bound are bridged to form a cyclic group which can be aliphatic or aromatic in nature, may be substituted and may contain one or more heteroatoms.

In a preferred embodiment, these catalyst systems comprise a catalyst of the general formula (A) together with a compound of the general formula (Z) in which the radicals R′ are identical and are either selected from the group consisting of methyl, ethyl, n-propyl, i-propyl, n-butyl, i-butyl, tert-butyl, n-pentyl, pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl, or two or three radicals R′ are bridged and then in each case two radicals R′ together form an alkylene radical, particularly preferably an ethylene, n-propylene or n-butylene radical, an alkenylene radical or an alkynylene radical.

In preferred catalysts of the general formula (A), one radical R is hydrogen and the other radical R is C₁-C₂₀-alkyl, C₃-C₁₀-Cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, alkylamino, C₁-C₃₀-alkylthio, C₆-C₂₄-arylthio, C₁-C₂₀-alkylsulphonyl or C₁-C₂₀-alkylsulphinyl, where these radicals may in each case be substituted by one or more alkyl, halogen, alkoxy, aryl or heteroaryl radicals.

In the catalysts of the general formula (A), X¹ and X² are identical or different and are two ligands, preferably anionic ligands.

X¹ and X² can be, for example, hydrogen, halogen, pseudohalogen, straight-chain or branched C₁-C₃₀-alkyl, C₆-C₂₄-aryl, C₁-C₂₀-alkoxy, C₆-C₂₄-aryloxy, C₃-C₂₀-alkyldiketonate C₆-C₂₄-aryldiketonate, C₁-C₂₀-carboxylate, C₁-C₂₀-alkylsulphonate, C₆-C₂₄-arylsulphonate, C₁-C₂₀-alkylthiol, C₆-C₂₄-arylthiol, C₁-C₁₀-alkylsulphonyl or C₁-C₂₀-alkylsulphinyl radicals.

The abovementioned radicals X¹ and X² can also be substituted by one or more further radicals, for example by halogen, preferably fluorine, C₁-C₁₀-alkyl, C₁-C₁₀-alkoxy or C₆-C₂₄-aryl, where these radicals, too, may once again be substituted by one or more substituents selected from the group consisting of halogen, preferably fluorine, C₁-C₅-alkyl, C₁-C₅-alkoxy and phenyl.

In a preferred embodiment, X¹ and X² are identical or different and are each halogen, in particular fluorine, chlorine, bromine or iodine, benzoate, C₁-C₅-carboxylate, C₁-C₅-alkyl, phenoxy, C₁-C₅-alkoxy, C₁-C₅-alkylthiol, C₆-C₂₄-arylthiol, C₆-C₂₄-aryl or C₁-C₅-alkylsulphonate.

In a particularly preferred embodiment, X¹ and X² are identical and are each halogen, in particular chlorine, CF₃COO, CH₃COO, CFH₂COO, (CH₃)₃CO, (CF₃)₂(CH₃)CO, (CF₃)(CH₃)₂CO, PhO (phenoxy), MeO (methoxy), EtO (ethoxy), tosylate (p-CH₃—C₆H₄—SO₃), mesylate (2,4,6-trimethylphenyl) or CF₃SO₃ (trifluoromethanesulphonate).

In the general formula (A), the symbols L represent identical or different ligands and are preferably uncharged electron donors.

The two ligands L can, for example, be, independently of one another, a phosphine, sulphonated phosphine, phosphate, phosphinite, phosphonite, arsine, stibine, ether, amine, amide, sulphoxide, carboxyl, nitrosyl, pyridine, thioether or imidazolidine (“Im”) ligand.

Preference is given to the two ligands L each being, independently of one another, a C₆-C₂₄-arylphosphine, C₁-C₁₀-alkylphospine or C₃-C₂₀-cycloalkylphosphine ligand, a sulphonated C₆-C₂₄-arylphosphine or sulphonated C₁-C₁₀-alkylphosphine ligand, a C₆-C₂₄-arylphosphinite or C₁-C₁₀-alkylphosphinite ligand, a C₆-C₂₄-arylphosphonite or C₁-C₁₀-alkylphosphonite ligand, a C₆-C₂₄-aryl phosphite or C₁-C₁₀-alkyl phosphite ligand, a C₆-C₂₄-arylarsine or C₁-C₁₀-alkylarsine ligand, a C₆-C₂₄-arylamine or C₁-C₁₀-alkylamine ligand, a pyridine ligand, a C₆-C₂₄-aryl sulphoxide or C₁-C₁₀-alkyl sulphoxide ligand, a C₆-C₂₄-aryl ether or C₁-C₁₀-alkyl ether ligand or a C₆-C₂₄-arylamide or C₁-C₁₀-alkylamide ligand, each of which may be substituted by a phenyl group which may in turn be substituted by a halogen-, C₁-C₅-alkyl or C₁-C₅-alkoxy radical.

The term “phosphine” includes, for example, PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃.

The term “phosphinite” includes, for example, phenyl diphenylphosphinite, cyclohexyl dicyclohexylphosphinite, isopropyl diisopropylphosphinite and methyl diphenylphosphinite.

The term “phosphite” includes, for example, triphenyl phosphite, tricyclohexyl phosphite, tri-tert-butyl phosphite, triisopropyl phosphite and methyl diphenyl phosphite.

The term “stibine” includes, for example, triphenylstibine, tricyclohexylstibine and trimethylstibine.

The term “sulphonate” includes, for example, trifluoromethanesulphonate, tosylate and mesylate. The term “sulphoxide” includes, for example, (CH₃)₂S(═O) and (C₆H₅)₂S═O.

The term “thioether” includes, for example, CH₃SCH₃, C₆H₅SCH₃, CH₃OCH₂CH₂SCH₃ and tetrahydrothiophene.

For the purposes of the present application, the term “pyridine” is used as a collective term for all nitrogen-containing ligands as are mentioned by, for example, Grubbs in WO-A-03/011455. Examples are: pyridine, picolines (α-, β- and γ-picoline), lutidines (2,3-, 2,4-, 2,5-, 2,6-, 3,4- and 3,5-lutidine), collidine (2,4,6-trimethylpyridine), trifluoromethylpyridine, phenylpyridine, 4-(dimethylamino)pyridine, chloropyridines, bromopyridines, nitropyridines, quinoline, pyrimidine, pyrrole, imidazole and phenylimidazole.

If one or both of the ligands L is an imidazolidine radical (Im), this usually has a structure corresponding to the general formulae (IIa) or (IIb),

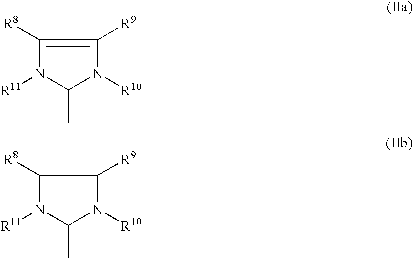

where
R⁸, R⁹, R¹⁰, R¹¹ are identical or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀ alkoxy, C₂-C₂₀-alkenyloxy, C₂-C₂₀-alkynyloxy, C₆-C₂₀-aryloxy, C₂-C₂₀-alkoxycarbonyl, C₁-C₂₀-alkylthio, C₆-C₂₀-arylthio, C₁-C₂₀-alkylsulphonyl, C₁-C₂₀-alkylsulphonate, C₆-C₂₀-arylsulphonate or C₁-C₂₀ alkylsulphinyl.

If appropriate, one or more of the radicals R⁸, R⁹, R¹⁰, R¹¹ can independently of one another, be substituted by one or more substituents, preferably straight-chain or branched C₁-C₁₀-alkyl, C₃-C₈-cycloalkyl, C₁-C₁₀-alkoxy or C₆-C₂₄-aryl, where these abovementioned substituents may in turn be substituted by one or more radicals, preferably radicals selected from the group consisting of halogen, in particular chlorine or bromine, C₁-C₅-alkyl, C₁-C₅-alkoxy and phenyl.

Merely in the interest of clarity, it may be added that the structures of the imidazolidine radical depicted in the general formulae (IIa) and (IIb) in the present patent application are equivalent to the structures (IIa′) and (IIb′) which are frequently also found in the literature for this imidazolidine radical (Im) and emphasize the carbene character of the imidazolidine radical This applies analogously to the associated preferred structures (IIIa)-(IIIf) depicted below.

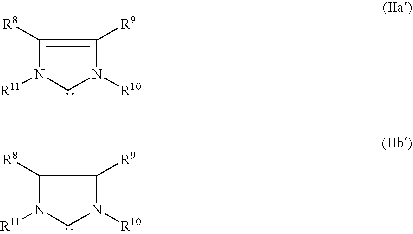

In a preferred embodiment of the catalysts of the general formula (A), R⁸ and R⁹ are each, independently of one another, hydrogen, C₆-C₂₄-aryl, particularly preferably phenyl, straight-chain or branched C₁-C₁₀-alkyl, particularly preferably propyl or butyl, or together with the carbon atoms to which they are bound form a cycloalkyl or aryl radical, where all the abovementioned radicals may in turn be substituted by one or more further radicals selected from the group consisting of straight-chain or branched C₁-C₁₀-alkyl, C₁-C₁₀-alkoxy, C₆-C₂₄-aryl and a functional group selected from the group consisting of hydroxy, thiol, thioether, ketone, aldehyde, ester, ether, amine, imine, amide, nitro, carboxylic acid, disulphide, carbonate, isocyanate, carbodiimide, carboalkoxy, carbamate and halogen.

In a preferred embodiment of the catalysts of the general formula (A), the radicals R¹⁰ and R¹¹ are identical or different and are each straight-chain or branched C₁-C₁₀-alkyl, particularly preferably i-propyl or neopentyl, C₃-C₁₀-cycloalkyl, preferably adamantyl, C₆-C₂₄-aryl, particularly preferably phenyl, C₁-C₁₀-alkylsulphonate, particularly preferably methanesulphonate, C₆-C₁₀-arylsulphonate, particularly preferably p-toluenesulphonate.

The abovementioned radicals as meanings of R¹⁰ and R¹¹ may be substituted by one or more further radicals selected from the group consisting of straight-chain or branched C₁-C₅-alkyl, in particular methyl, C₁-C₅-alkoxy, aryl and a functional group selected from the group consisting of hydroxy, thiol, thioether, ketone, aldehyde, ester, ether, amine, imine, amide, nitro, carboxylic acid, disulphide, carbonate, isocyanate, carbodiimide, carboalkoxy, carbamate and halogen.

In particular, the radicals R¹⁰ and R¹¹ can be identical or different and are each i-propyl, neopentyl, adamantyl, mesityl or 2,6-diisopropylphenyl.

Particularly preferred imidazolidine radicals (Im) have the following structures (IIIa) to (IIIf), where Ph is in each case a phenyl radical, Bu is a butyl radical and Mes is in each case a 2,4,6-trimethylphenyl radical or Mes is alternatively in all cases 2,6-diisopropylphenyl.

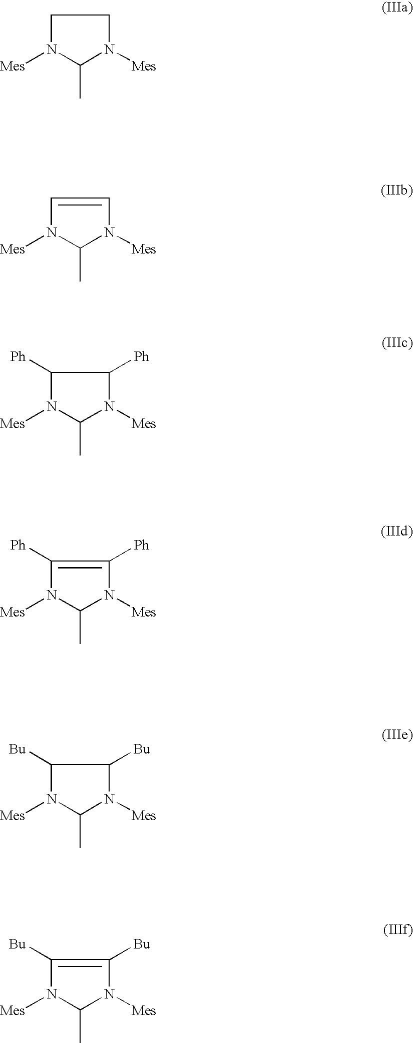

Various representatives of the catalysts of the formula (A) are known in principle, e.g. from WO-A-96/04289 and WO-A-97/06185.

As an alternative to the preferred Im radicals, one or both ligands L in the general formula (A) are also preferably identical or different trialkylphosphine ligands in which at least one of the alkyl groups is a secondary alkyl group or a cycloalkyl group, preferably isopropyl, isobutyl, sec-butyl, neopentyl, cyclopentyl or cyclohexyl.

Particular preference is given to one or both ligands L in the general formula (A) being a trialkylphosphine ligand in which at least one of the alkyl groups is a secondary alkyl group or a cycloalkyl group, preferably isopropyl, isobutyl, sec-butyl, neopentyl, cyclopentyl or cyclohexyl.

Particular preference is given to catalyst systems comprising, in addition to at least one compound of the general formula (Z), one of the two catalysts below, which come under the general formula (A) and have the structures (IV) (Grubbs (I) catalyst) and (V) (Grubbs (II) catalyst), where Cy is cyclohexyl.

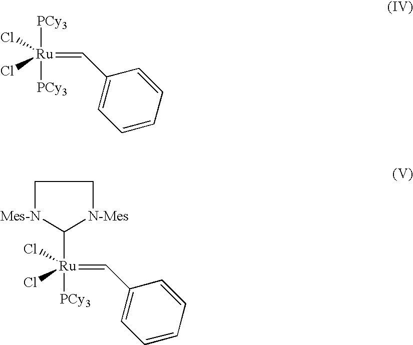

In a further embodiment, use is made of, in addition to at least one compound of the general formula (Z), a catalyst of the general formula (A1),

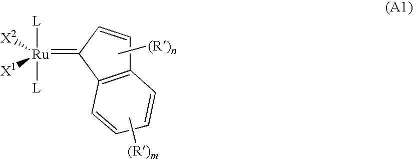

where
X¹, X² and L can have the same general, preferred and particularly preferred meanings as in the general formula (A),
n is 0, 1 or 2,
m is 0, 1, 2, 3 or 4 and
the radicals R′ are identical or different and are alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals which may in each case be substituted by one or more alkyl, halogen, alkoxy, aryl or heteroaryl radicals.

As preferred catalyst coming under the general formula (A1), it is possible to use, for example, the catalyst of the formula (VI) below, where Mes is in each case 2,4,6-trimethylphenyl and Ph is phenyl.

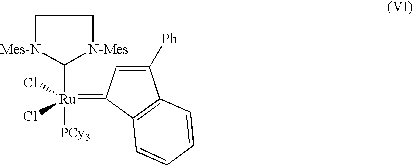

This catalyst which is also referred to in the literature as “Nolan catalyst” is known, for example, from WO-A-2004/112951.

The particularly preferred catalyst systems according to the invention comprise the catalysts of the formulae (IV), (V) or (VI) together with a compound of the general formula (Z) in which the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-methylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

Further suitable catalyst systems according to the invention are systems which comprise, in addition to at least one compound of the general formula (Z), a catalyst of the general formula (B),

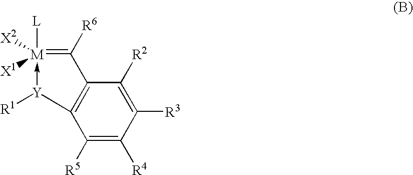

where
M is ruthenium or osmium,
X¹ and X² are identical or different ligands, preferably anionic ligands,
Y is oxygen (O), sulphur (S), an N—R¹ radical or a P—R¹ radical, where R¹ is as defined below,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical which may in each case optionally be substituted by one or more alkyl, halogen, alkoxy, aryl or heteroaryl radicals,
R², R³, R⁴ and R⁵ are identical or different and are each hydrogen or an organic or inorganic radical,
R⁶ is hydrogen or an alkyl, alkenyl, alkynyl or aryl radical and
L is a ligand which has the same meanings as in formula (A).

These catalyst systems preferably comprise the catalyst of the general formula (B) together with a compound of the general formula (Z) in which the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

The catalysts of the general formula (B) are known in principle. Representatives of this class of compounds are the catalysts described by Hoveyda et al. in US 2002/0107138 A1 and Angew Chem. Int. Ed. 2003, 42, 4592, and the catalysts described by Grela in WO-A-2004/035596, Eur. J. Org. Chem. 2003, 963-966 and Angew. Chem. Int. Ed. 2002, 41, 4038 and also in J. Org. Chem. 2004, 69, 6894-96 and Chem. Eur. J. 2004, 10, 777-784. The catalysts are commercially available or can be prepared as described in the literature references cited.

In the catalysts of the general formula (B), L is a ligand which usually possesses an electron donor function and can have the same general, preferred and particularly preferred meanings as L in the general formula (A).

Furthermore, L in the general formula (B) is preferably a P(R⁷)₃ radical, where the radicals R⁷ are each, independently of one another, C₁-C₆-alkyl, C₃-C₈-cycloalkyl or aryl, or else a substituted or unsubstituted imidazolidine radical (“Im”).

C₁-C₆-alkyl is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-cycloalkyl encompasses cyclopropyl, cyclobutyl, cyclopentyl, cyclohexyl, cycloheptyl and cyclooctyl.

Aryl is an aromatic radical having from 6 to 24 skeletal carbon atoms. As preferred monocyclic, bicyclic or tricyclic carbocyclic aromatic radicals having from 6 to 10 skeletal carbon atoms, mention may be made by way of example of phenyl, biphenyl, naphthyl, phenanthrenyl or anthracenyl.

The imidazolidine radical (Im) usually has a structure of the general formula (IIa) or (IIb),

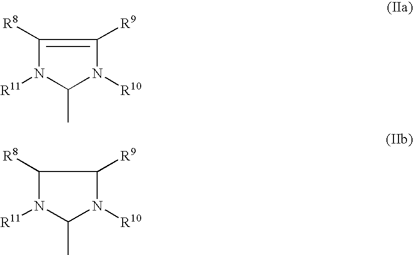

where
R⁸, R⁹, R¹⁰, R¹¹ are identical or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₀-aryloxy, C₂-C₂₀-alkoxycarbonyl, C₁-C₂₀-alkylthio, C₆-C₂₀-arylthio, C₁-C₂₀-alkylsulphonyl, C₁-C₂₀-alkylsulphonate, C₆-C₂₀-arylsulphonate or C₁-C₂₀-alkylsulphinyl.

If appropriate, one or more of the radicals R⁸, R⁹, R¹⁰, R¹¹ may, independently of one another, be substituted by one or more substituents, preferably straight-chain or branched C₁-C₁₀-alkyl, C₃-C₈-cycloalkyl, C₁-C₁₀-alkoxy or C₆-C₂₄-aryl, where these abovementioned substituents may in turn be substituted by one or more radicals, preferably radicals selected from the group consisting of halogen, in particular chlorine or bromine, C₁-C₅-alkyl, C₁-C₅-alkoxy and phenyl.

In a preferred embodiment of the catalyst system according to the invention, use is made of, in addition to at least one compound of the general formula (Z), catalysts of the general formula (B) in which R⁸ and R⁹ are each, independently of one another, hydrogen, C₆-C₂₄-aryl, particularly preferably phenyl, straight-chain or branched C₁-C₁₀-alkyl, particularly preferably propyl or butyl, or together with the carbon atoms to which they are bound form a cycloalkyl or aryl radial, where all the abovementioned radicals may in turn be substituted by one or more further radicals selected from the group consisting of straight-chain or branched C₁-C₁₀-alkyl, C₁-C₁₀-alkoxy, C₆-C₂₄-aryl and a functional group selected from the group consisting of hydroxy, thiol, thioether, ketone, aldehyde, ester, ether, amine, imine, amide, nitro, carboxylic acid, disulphide, carbonate, isocyanate, carbodiimide, carboalkoxy, carbamate and halogen.

In a further preferred embodiment of the catalyst system according to the invention, use is made of, in addition to at least one compound of the general formula (Z), catalysts of the general formula (B) in which the radicals R¹⁰ and R¹¹ are identical or different and are each straight-chain or branched C₁-C₁₀-alkyl, particularly preferably i-propyl or neopentyl, C₃-C₁₀-cycloalkyl, preferably adamantyl, C₆-C₂₄-aryl, particularly preferably phenyl, C₁-C₁₀-alkylsulphonate, particularly preferably methanesulphonate, or C₆-C₁₀-arylsulphonate, particularly preferably p-toluenesulphonate.

The abovementioned radicals as meanings of R¹⁰ and R¹¹ may be substituted by one or more further radicals selected from the group consisting of straight-chain or branched C₁-C₅-alkyl, in particular methyl, C₁-C₅-alkoxy, aryl and a functional group selected from the group consisting of hydroxy, thiol, thioether, ketone, aldehyde, ester, ether, amine, imine, amide, nitro, carboxylic acid, disulphide, carbonate, isocyanate, carbodiimide, carboalkoxy, carbamate and halogen.

In particular, the radicals R¹⁰ and R¹¹ can be identical or different and are each i-propyl, neopentyl, adamantyl or mesityl.

Particularly preferred imidazolidine radicals (Im) have the structures (IIIa-IIIf) mentioned above, where Mes is in each case 2,4,6-trimethylphenyl.

In the catalysts of the general formula (B), X¹ and X² are identical or different and can each be, for example, hydrogen, halogen, pseudohalogen, straight-chain or branched C₁-C₃₀-alkyl, C₆-C₂₄-aryl, C₁-C₂₀-alkoxy, C₆-C₂₄-aryloxy, C₃-C₂₀-alkyldiketonate, C₆-C₂₄-aryldiketonate, C₁-C₂₀-carboxylate, alkylsulphonate, C₆-C₂₄-arylsulphonate, C₁-C₂₀-alkylthiol, C₆-C₂₄-arylthiol, C₁-C₂₀-alkylsulphonyl or C₁-C₂₀-alkylsulphinyl.

The abovementioned radicals X¹ and X² can also be substituted by one or more further radicals, for example by halogen, preferably fluorine, C₁-C₁₀-alkyl, C₁-C₁₀-alkoxy or C₆-C₂₄-aryl, where the latter radicals may in turn also be substituted by one or more substituents selected from the group consisting of halogen, preferably fluorine, C₁-C₅-alkyl, C₁-C₅-alkoxy and phenyl.

In a preferred embodiment, X¹ and X² are identical or different and are each halogen, in particular fluorine, chlorine, bromine or iodine, benzoate, C₁-C₅-carboxylate, C₁-C₅-alkyl, phenoxy, C₁-C₅-alkoxy, C₁-C₅-alkylthiol, C₆-C₂₄-arylthiol, C₆-C₂₄-aryl or C₁-C₅-alkylsulphonate.

In a particularly preferred embodiment, X¹ and X² are identical and are each halogen, in particular chlorine, CF₃COO, CH₃COO, CFH₂COO, (CH₃)₃CO, (CF₃)₂(CH₃)CO, (CF₃)(CH₃)₂CO, PhO (phenoxy), MeO (methoxy), EtO (ethoxy), tosylate (p-CH₃—C₆H₄—SO₃), mesylate (2,4,6-trimethylphenyl) or CF₃SO₃ (trifluoromethanesulphonate).

In the general formula (B), the radical R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical which may in each case optionally be substituted by one or more alkyl, halogen, alkoxy, aryl or heteroaryl radicals.

The radical R¹ is usually a C₁-C₃₀-alkyl, C₃-C₂₀-cycloalkyl, C₂-C₂₀-alkenyl, C₂-C₂₀-alkynyl, C₆-C₂₄-aryl, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylamino, C₁-C₂₀-alkylthio, C₆-C₂₄-arylthio, C₁-C₂₀-alkylsulphonyl or C₁-C₂₀-alkylsulphinyl radical which may in each case optionally be substituted by one or more alkyl, halogen, alkoxy, aryl or heteroaryl radicals.

R¹ is preferably a C₃-C₂₀-cylcoalkyl radical, a C₆-C₂₄-aryl radical or a straight-chain or branched C₁-C₃₀-alkyl radical, with the latter being able, if appropriate, to be interrupted by one or more double or triple bonds or one or more heteroatoms, preferably oxygen or nitrogen. R¹ is particularly preferably a straight-chain or branched C₁-C₁₂-alkyl radical.

C₃-C₂₀-Cycloalkyl radicals encompass, for example, cyclopropyl, cyclobutyl, cyclopentyl, cyclohexyl, cycloheptyl and cyclooctyl.

A C₁-C₁₂-alkyl radical can be, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, n-hexyl, n-heptyl, n-octyl, n-decyl or n-dodecyl. In particular, R¹ is methyl or isopropyl.

A C₆-C₂₄-aryl radical is an aromatic radical having from 6 to 24 skeletal carbon atoms. As preferred monocyclic, bicyclic or tricyclic carbocyclic aromatic radicals having from 6 to 10 skeletal carbon atoms, mention may be made by way of example of phenyl, biphenyl, naphthyl, phenanthrenyl or anthracenyl.

In the general formula (B), the radicals R², R³, R⁴ and R⁵ are identical or different and can each be hydrogen or an organic or inorganic radical.

In an appropriate embodiment. R², R³, R⁴, R⁵ are identical or different and are each hydrogen, halogen, nitro, CF₃, alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl which may be in each case optionally be substituted by one or more alkyl, alkoxy, halogen, aryl or heteroaryl radicals.

R², R³, R⁴, R⁵ are usually identical or different and are each hydrogen, halogen, preferably chlorine or bromine, nitro, CF₃, C₁-C₃₀-alkyl, C₃-C₂₀-cylcoalkyl, C₂-C₂₀-alkenyl, C₂-C₂₀-alkynyl, C₆-C₂₄-aryl, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylamino, C₁-C₂₀ alkylthio, C₆-C₂₄-arylthio, C₁-C₂₀-alkylsulphonyl or C₁-C₂₀-alkylsulphinyl which may in each case optionally be substituted by one or more C₁-C₁₀-alkyl, C₁-C₂₀-alkoxy, halogen, C₆-C₂₄-aryl or heteroaryl radicals.

In a particularly useful embodiment, R², R³, R⁴, R⁵ are identical or different and are each nitro, straight-chain or branched C₁-C₃₀-alkyl, C₅-C₂₀-cylcoalkyl, straight-chain or branched C₁-C₂₀-alkoxy or C₆-C₂₄-aryl radicals, preferably phenyl or naphthyl. The C₁-C₃₀-alkyl radicals and C₁-C₂₀-alkoxy radicals may optionally be interrupted by one or more double or triple bonds or one or more heteroatoms, preferably oxygen or nitrogen.

Furthermore, two or more of the radicals R², R³, R⁴ or R⁵ can also be bridged via aliphatic or aromatic structures. For example, R³ and R⁴ together with the carbon atoms to which they are bound in the phenyl ring of the formula (B) can form a fused-on phenyl ring so that, overall, a naphthyl structure results.

In the general formula (B), the radical R⁶ is hydrogen or an alkyl, alkenyl, alkynyl or aryl radical. R⁶ is preferably hydrogen, a C₁-C₃₀-alkyl radical, a C₂-C₂₀-alkenyl radical, a C₂-C₂₀-alkynyl radical or a C₆-C₂₄-aryl radical. R⁶ is particularly preferably hydrogen.

Further suitable catalyst systems are ones which comprise, in addition to at least one compound of the general formula (Z), a catalyst of the general formula (B1),

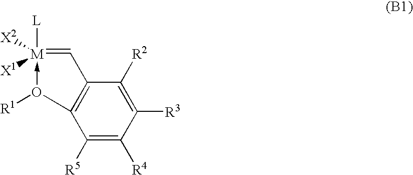

where
M, L, X¹, X², R¹, R², R³, R⁴ and R⁵ can have the general, preferred and particularly preferred meanings mentioned for the general formula (B).

These catalyst systems preferably comprise the catalyst of the general formula (B1) together with a compound of the general formula (Z) in which the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene or an alkynylene radical.

The catalysts of the general formula (B1) are known in principle from, for example, US 2002/0107138 A1 (Hoveyda et al.) and can be obtained by preparative methods indicated there.

Particular preference is given to catalyst systems comprising catalysts of the general formula (B1) in which

M is ruthenium,
X¹ and X² are both halogen, in particular both chlorine,
R¹ is a straight-chain or branched C₁-C₁₂-alkyl radical,
R², R³, R⁴, R⁵ have the general and preferred meanings mentioned for the general formula (B) and
L has the general and preferred meanings mentioned for the general formula (B).

Special preference is given to catalyst systems comprising catalysts of the general formula (B1) in which

M is ruthenium,
X¹ and X² are both chlorine,
R¹is an isopropyl radical,
R², R³, R⁴, R⁵ are all hydrogen and
L is a substituted or unsubstituted imidazolidine radical of the formula (IIa) or (IIb),

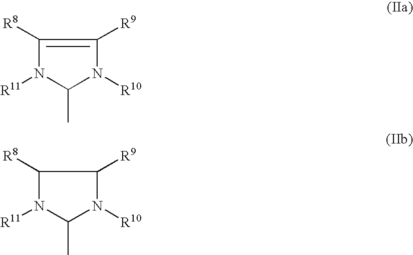

where
R⁸, R⁹, R¹⁰, R¹¹ are identical or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₆-C₂₄-arylthio, alkylsulphonyl, C₁-C₂₀-alkylsulphonate, C₆-C₂₄-arylsulphonate or C₁-C₂₀-alkylsulphinyl, where the abovementioned radicals may in each case be substituted by one or more substituents, preferably straight-chain or branched C₁-C₁₀-alkyl, C₃-C₈-cycloalkyl, C₁-C₁₀-alkoxy or C₆-C₂₄-aryl, and these abovementioned substituents may in turn be substituted by one or more radicals, preferably radicals selected from the group consisting of halogen, in particular chlorine or bromine, C₁-C₅-alkyl, C₁-Cₛ-alkoxy and phenyl.

Very particular preference is given to a catalyst system comprising at least one compound of the general formula (Z) and a catalyst which comes under the general structural formula (B1) and has the formula (VII), where Mes is in each case 2,4,6-trimethylphenyl.

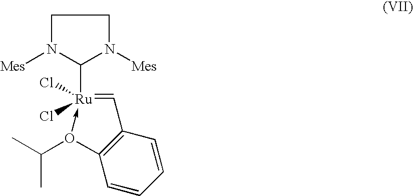

This catalyst (VII) is also referred to as “Hoveyda catalyst” in the literature.

Further suitable catalyst systems are those which, in addition to at least one compound of the general formula (Z), comprise a catalyst which comes under the general structural formula (B1) and has one of the formulae (VIII), (IX), (X), (XI), (XII), (XIII), (XIV) and (XV) below, where Mes is in each case 2,4,6-trimethylphenyl.

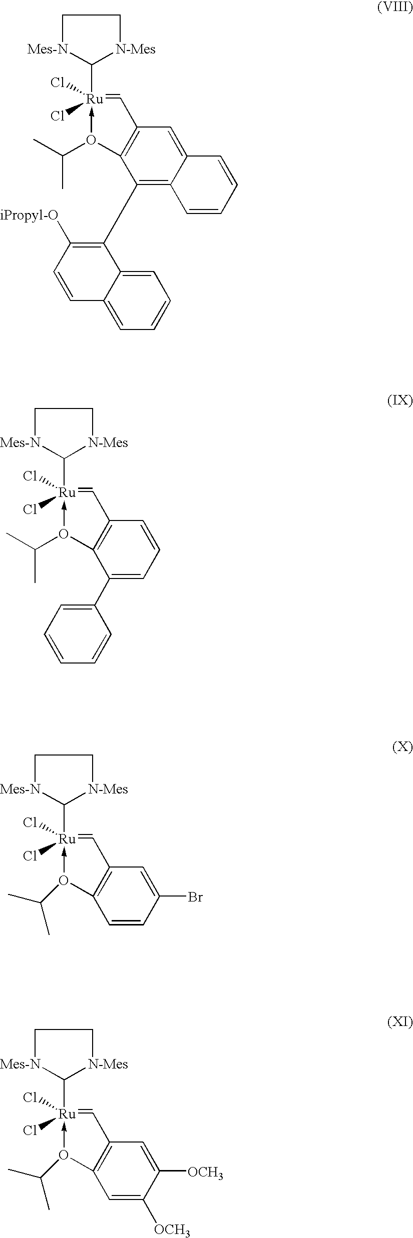

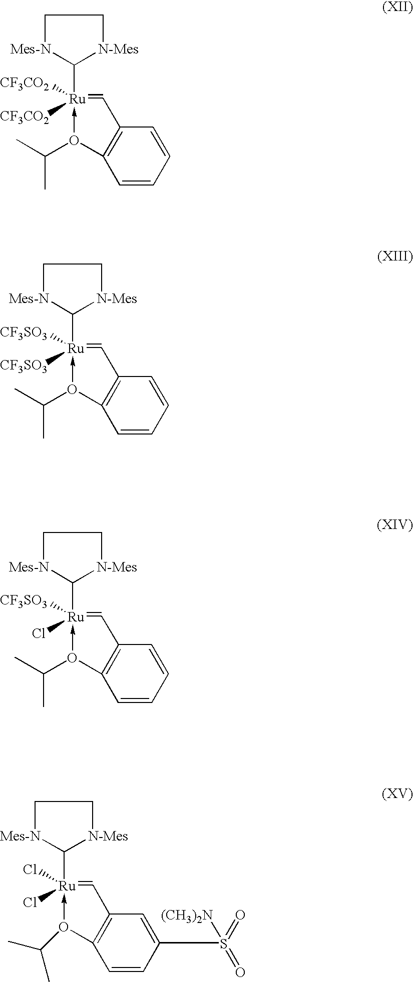

A further catalyst system according to the invention comprises at least one compound of the general formula (Z) and a catalyst of the general formula (B2),

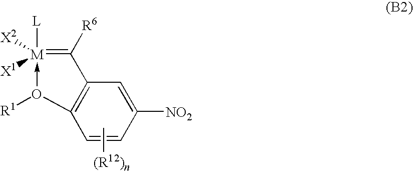

where
M, L, X¹, X², R¹ and R⁶ have the general and preferred meanings mentioned for the formula (B),
the radicals R¹² are identical or different and have the general and preferred meanings, with the exception of hydrogen, mentioned for the radicals R², R³, R⁴ and R⁵ in the formula (B) and
n is 0, 1, 2 or 3.

These catalyst systems preferably comprise the catalyst of the general formula (B2) together with a compound of the general formula (Z) in which, once again, the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

The catalysts of the general formula (B2) are known in principle from, for example, WO-A-2004/035596 (Grela) and can be obtained by preparative methods indicated there.

Particular preference is given to catalyst systems comprising at least one catalyst of the general formula (Z) and a catalyst of the general formula (B2) in which

M is ruthenium,
X¹ and X² are both halogen, in particular both chlorine,
R¹ is a straight-chain or branched C₁-C₁₂-alkyl radical,
R¹² has the meanings mentioned for the general formula (B2),
n is 0, 1, 2 or 3,
R⁶ is hydrogen and
L has the meanings mentioned for the general formula (B).

Very particular preference is given to catalyst systems comprising at least one compound of the general formula (Z) and a catalyst of the general formula (B2) in which
M is ruthenium,
X¹ and X² are both chlorine,
R¹ is an isopropyl radical,
n is 0 and
L is a substituted or unsubstituted imidazolidine radical of the formulae (IIa) or (IIb), where R⁸, R⁹, R¹⁰, R¹¹ are identical or different and have the meanings mentioned for the very particularly preferred catalysts of the general formula (B1).

A particularly useful catalyst system comprises a catalyst having the structure (XVI) below and also a compound of the general formula (Z) in which the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

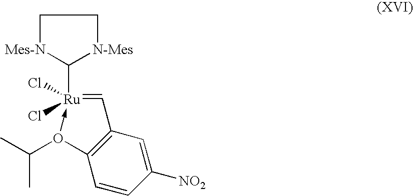

The catalyst (XVI) is also referred to as “Grela catalyst” in the literature.

A further suitable catalyst system comprises at least one compound of the general formula (Z) and a catalyst which comes under the general formula (B2) and has the structure (XVII), where Mes is in each case 2,4,6-trimethylphenyl.

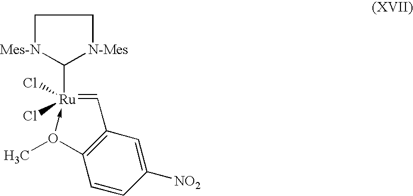

An alternative embodiment provides catalyst systems comprising at least one compound of the general formula (Z) and a catalyst of the general formula (B3) having a dendritic structure,

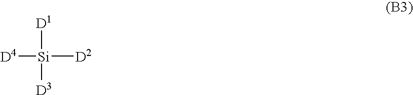

where D¹, D², D³ and D⁴ each have a structure of the general formula (XVIII) shown below which is bound via the methylene group shown at right to the silicon of the formula (B3),

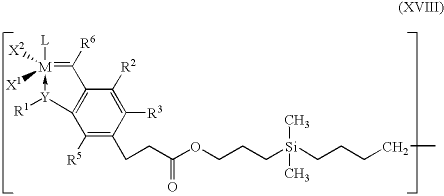

where
M, L, X¹, X², R¹, R², R³, R⁵ and R⁶ can have the general and preferred meanings mentioned for the general formula (B).

These catalyst systems preferably contain the catalyst of the general formula (B3) together with a compound of the general formula (Z) in which the radicals R¹ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

The catalysts of the general formula (B3) are known from US 2002/0107138 A1 and can be prepared as described there.

A further alternative embodiment provides a catalyst system comprising at least one compound of the general formula (Z) and a catalyst of the formula (B4),

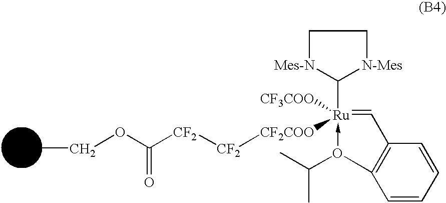

where the symbol [symbol] represents a support.

The support is preferably a poly(styrene-divinylbenzene) copolymer (PS-DVB).

The catalysts of the formula (B4) are known in principle from Chem. Eur. J. 2004 10, 777-784 and can be obtained by the preparative methods described there.

All the abovementioned catalysts of type (B) can either be used as such in the reaction mixture of the NBR metathesis or can be applied to and immobilized on a solid support. Suitable solid phases or supports are materials which firstly are inert towards the reaction mixture of the metathesis and secondly do not adversely affect the activity of the catalyst. To immobilize the catalyst, it is possible to use, for example, metals, glass, polymers, ceramic, organic polymer spheres or inorganic sol-gels, carbon black, silicates, silicates, calcium carbonate and barium sulphate.

A further embodiment provides catalyst systems comprising at least one compound of the general formula (Z) and a catalyst of the general formula (C),

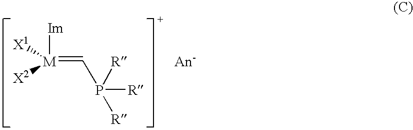

where
M is ruthenium or osmium,
X¹ and X² are identical or different and are anionic ligands,
the radicals R″ are identical or different and are organic radicals,
Im is a substituted or unsubstituted imidazolidine radical and
An is an anion.

These catalyst systems preferably contain the catalyst of the general formula (C) together with a compound of the general formula (Z) in which the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

The catalysts of the general formula (C) are known in principle (see, for example, Angew. Chem. Int. Ed. 2004, 43, 6161-6165).

X¹ and X² in the general formula (C) can have the same general, preferred and particularly preferred meanings as in the formulae (A) and (B).

The imidazolidine radical (Im) usually has a structure of the general formula (IIa) or (IIb) which have been mentioned above for the catalyst type of the formulae (A) and (B) and can have all the structures mentioned there as preferred, in particular those of the formulae (IIIa)-(IIIf).

The radicals R″ in the general formula (C) are identical or different and are each a straight-chain or branched C₁-C₃₀-alkyl, C₅-C₃₀-cycloalkyl or aryl radical, where the C₁-C₃₀-alkyl radicals may be interrupted by one or more double or triple bonds or one or more heteroatoms, preferably oxygen or nitrogen.

Aryl is an aromatic radical having from 6 to 24 skeletal carbon atoms. As preferred monocyclic, bicyclic or tricyclic carbocyclic aromatic radicals having from 6 to 10 skeletal carbon atoms, mention may be made by way of example of phenyl, biphenyl, naphthyl, phenanthrenyl or anthracenyl.

Preference is given to the radicals R″ in the general formula (C) being identical and each being phenyl, cyclohexyl, cyclopentyl, isopropyl, o-tolyl, o-xylyl or mesityl.

A further alternative embodiment provides a catalyst system comprising at least one compound of the general formula (Z) and a catalyst of the general formula (D)

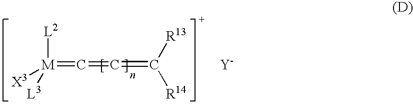

where
M is ruthenium or osmium,
R¹³ and R¹⁴ are each, independently of one another, hydrogen, C₁-C₂₀-alkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀-alkylsulphinyl,
X³ is an anionic ligand,
L² is an uncharged π-bonded ligand which may either be monocyclic or polycyclic,
L³ is a ligand selected from the group consisting of phosphines, sulphonated phosphines, fluorinated phosphines, functionalized phosphines having up to three aminoalkyl, ammonioalkyl, alkoxyalkyl, alkoxycarbonylalkyl, hydrocarbonylalkyl, hydroxyalkyl or ketoalkyl groups, phosphites, phosphinites, phosphonites, phosphinamines, arsines stibines, ethers, amines, amides, imines, sulphoxides, thioethers and pyridines,
Y⁻ is a noncoordinating anion and
n is 0, 1, 2, 3, 4 or 5.

These catalyst systems preferably contain the catalyst of the general formula (D) together with a compound of the general formula (Z) in which the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

A further embodiment provides a catalyst system comprising at least one compound of the general formula (Z) and a catalyst of the general formula (E),

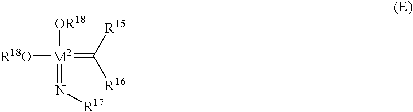

where
M² is molybdenum,
R¹⁵ and R¹⁶ are identical or different and are each hydrogen, C₁-C₁₀-alkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀-alkylsulphinyl,
R¹⁷ and R¹⁸ are identical or different and are each a substituted or halogen-substituted C₁-C₁₀-alkyl, C₆-C₂₄-aryl, C₆-C₃₀-aralkyl radical or a silicone-containing analogue thereof.

These catalyst systems preferably contain the catalyst system of the general formula (E) together with a compound of the general formula (Z) in which the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

A further alternative embodiment provides a catalyst system comprising at least one compound of the general formula (Z) and a catalyst of the general formula (F),

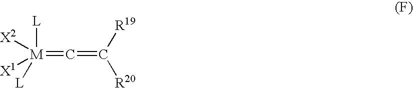

where
M is ruthenium or osmium,
X¹ and X² are identical or different and are anionic ligands which can have all meanings of X¹ and X² mentioned in the general formulae (A) and (B),
the symbols L represent identical or different ligands which can have all general and preferred meanings of L mentioned in the general formulae (A) and (B),
R¹⁹ and R²⁰ are identical or different and are each hydrogen or substituted or unsubstituted alkyl.

These catalyst systems preferably contain the catalyst system of the general formula (F) together with a compound of the general formula (Z) in which the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

A further alternative embodiment provides a catalyst system according to the invention comprising at least one compound of the general formula (Z) and a catalyst of the general formula (G), (H) or (K),

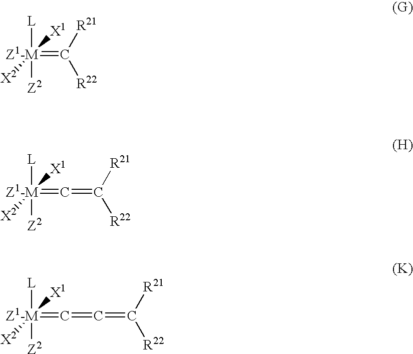

where
M is osmium or ruthenium,
X¹ and X² are identical or different and are two ligands, preferably anionic ligands,
L is a ligand, preferably an uncharged electron donor,
Z¹ and Z² are identical or different and are uncharged electron donors,
R²¹ and R²² are each, independently of one another, hydrogen alkyl, cycloalkyl, alkenyl, alkynyl, aryl, carboxylate, alkoxy, alkenyloxy, alkynyloxy, aryloxy, alkoxycarbonyl, alkylamino, alkylthio, alkylsulphonyl or alkylsulphinyl which are in each case substituted by one or more radicals selected from among alkyl, halogen, alkoxy, aryl or heteroaryl.

The catalysts of the general formulae (G), (H) and (K) are known in principle, e.g. from WO 2003/011455 A1, WO 2003/087167 A2, Organometallics 2001, 20, 5314 and Angew. Chem. Int. Ed. 2002, 41, 4038. The catalysts are commercially available or can be synthesized by the preparative methods indicated in the abovementioned literature references.

### Z¹ and Z²

In the catalyst systems which can be used according to the invention, catalysts of the general formulae (G), (H) and (K) in which Z¹ and Z² are identical or different and are uncharged electron donors are used. These ligands are usually weakly coordinating. The ligands are typically optionally substituted heterocyclic groups. These can be five- or six-membered monocyclic groups having from 1 to 4, preferably from 1 to 3 and particularly preferably 1 or 2, heteroatoms or bicyclic or polycyclic structures made up of 2, 3, 4 or 5 five- or six-membered monocyclic groups of this type, where all the abovementioned groups may in each case optionally be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₅-C₂₃-heteroaryl, radicals which may in turn each be substituted by one or more groups, preferably groups selected from the group consisting of halogen, in particular chlorine or bromine, C₁-C₅-alkyl, C₁-C₅-alkoxy and phenyl.

Examples of Z¹ and Z² encompass nitrogen-containing heterocycles such as pyridines, pyridazines, bipyridines, pyrimidines, pyrazines, pyrazolidines, pyrrolidines, piperazines, indazoles, quinolines, purines, acridines, bisimidazoles, picolylimines, imidazolidines and pyrroles.

Z¹ and Z² can also be bridged to one another to form a cyclic structure. In this case, Z¹ and Z² form a single bidentate ligand.

### L

In the catalysts of the general formulae (G), (H) and (K), L can have the same general, preferred and particularly preferred meanings as L in the general formula (A) and (B).

### R²¹ and R²²

In the catalysts of the general formulae (G), (H) and (K), R²¹ and R²² are identical or different and are each alkyl, preferably C₁-C₃₀-alkyl, particularly preferably C₁-C₂₀-alkyl, cycloalkyl, preferably C₃-C₂₀-cycloalkyl, particularly preferably C₃-C₈-cycloalkyl, alkenyl, preferably C₂-C₂₀-alkenyl, particularly preferably C₂-C₁₆-alkenyl, alkynyl, preferably C₂-C₂₀-alkynyl, particularly preferably C₂-C₁₆-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, or alkylsulphinyl, preferably C₁-C₂₀-alkylsulphinyl, where the abovementioned substituents may be substituted by one or more alkyl, halogen, alkoxy, aryl or heteroaryl radicals.

### X¹ and X²

In the catalysts of the general formulae (G), (H) and (K), X¹ and X² are identical or different and can have the same general, preferred and particularly preferred meanings as indicated above for X¹ and X² in the general formula (A).

Preference is given to using catalysts of the general formulae (G), (H) and (K) in which
M is ruthenium,
X¹ and X² are both halogen, in particular chlorine,
R¹ and R² are identical or different and are five- or six-membered monocyclic groups having from 1 to 4, preferably from 1 to 3 and particularly preferably 1 or 2, heteroatoms or bicyclic or polycyclic structures made up of 2, 3, 4 or 5 five- or six-membered monocyclic groups of this type, where all the abovementioned groups may in each case be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₅-C₂₃-heteroaryl, radicals,
R²¹ and R²² are identical or different and are each C₁-C₃₀-alkyl C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl, C₁-C₂₀-alkylsulphinyl, and
L has a structure of the above-described general formula (IIa) or (IIb), in particular one of the formulae (IIIa) to (IIIf).

A particularly preferred catalyst which comes under the general formula (G) has the structure (XIX),

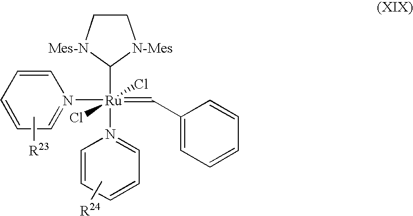

where
R²³ and R²⁴ are identical or different and are each halogen, straight-chain or branched C₁-C₂₀-alkyl, C₁-C₂₀-heteroalkyl, C₁-C₁₀-haloalkyl, C₁-C₁₀-alkoxy, C₆-C₂₄-aryl, preferably phenyl, formyl, nitro, a nitrogen heterocycle, preferably pyridine, piperidine or pyrazine, carboxy, alkylcarbonyl, halocarbonyl, carbamoyl, thiocarbamoyl, carbamido, thioformyl, amino, dialkylamino, trialkylsilyl or trialkoxysilyl.

The abovementioned radicals C₁-C₂₀-alkyl, C₁-C₂₀-heteroalkyl, C₁-C₁₀-haloalkyl, C₁-C₁₀-alkoxy, C₆-C₂₄-aryl, preferably phenyl, formyl, nitro, a nitrogen heterocycle, preferably pyridine, piperidine or pyrazine, carboxy, alkylcarbonyl, halocarbonyl, carbamoyl, thiocarbamoyl, carbamido, thioformyl, amino, trialkylsilyl and trialkoxysilyl may in turn each be substituted by one or more halogen, preferably fluorine, chlorine or bromine, C₁-C₅-alkyl, C₁-C₅-alkoxy or phenyl radicals. Particularly preferred embodiments of the catalyst of the formula (XIX) have the structure (XIX a) or (XIX b), where R²³ and R²⁴ have the same meanings as indicated in the formula (XIX).

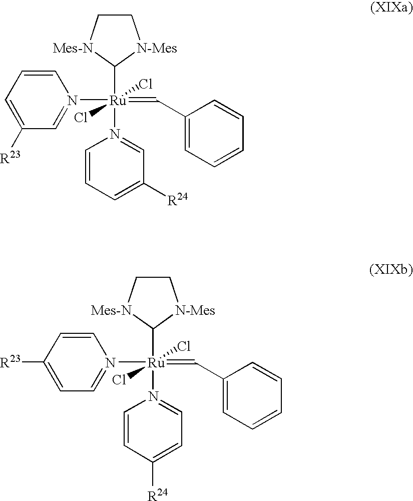

When R²³ and R²⁴ are each hydrogen, the catalyst is referred to in the literature as the “Grubbs III catalyst”.

Further suitable catalysts which come under the general formulae (G), (H) and (K) have the following structural formulae (XX)-(XXXI), where Mes is in each case 2,4,6-trimethylphenyl.

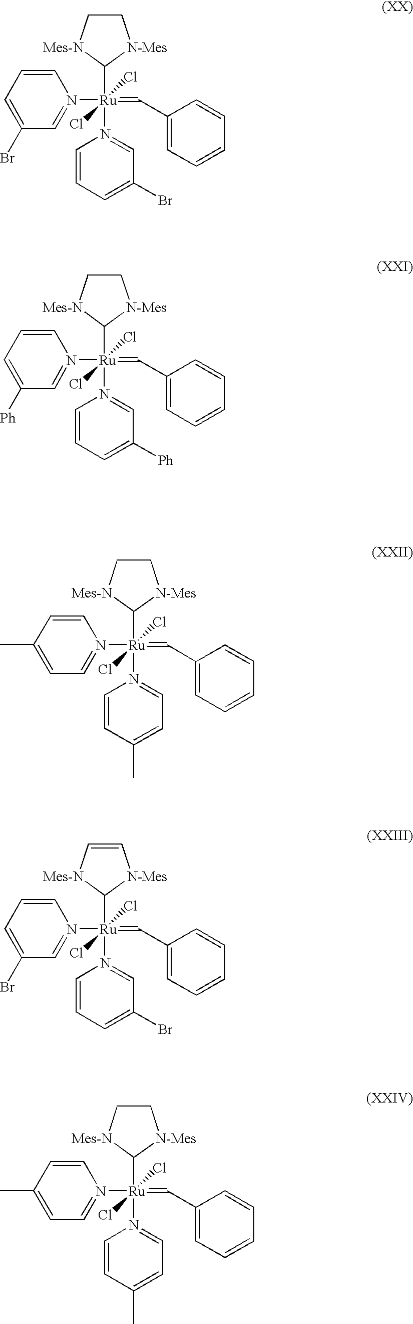

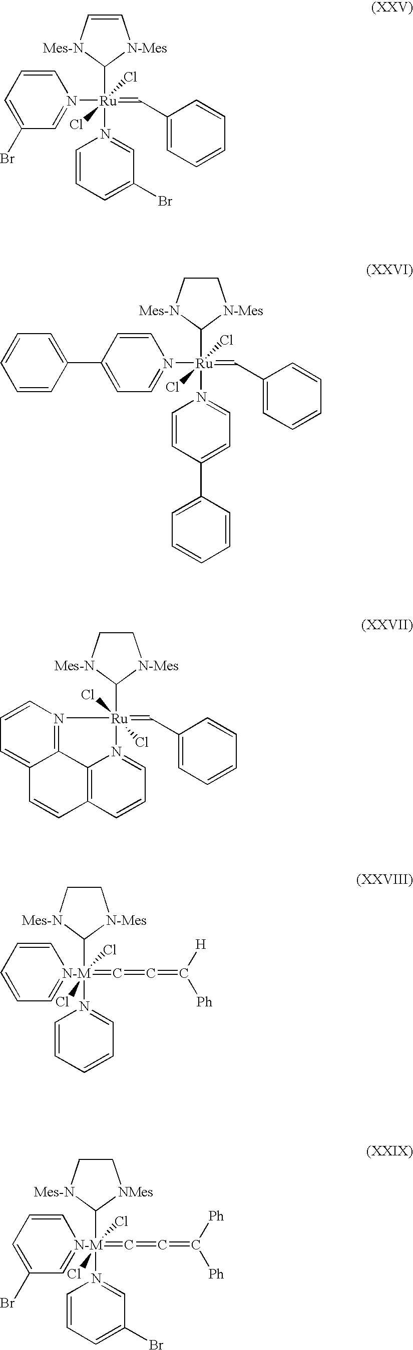

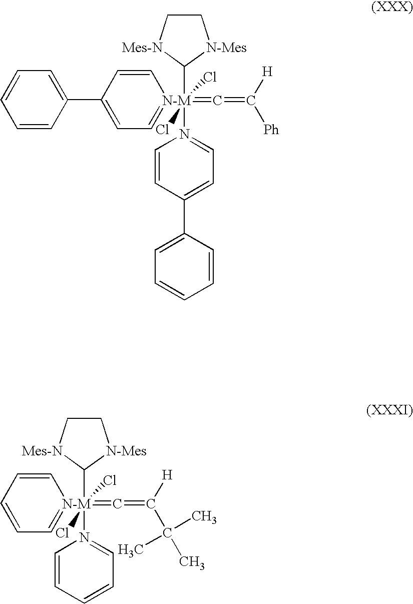

These catalyst systems preferably contain the catalyst of the general structural formulae (XX)-(XXXI) together with a compound of the general formula (Z) in which the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

A further alternative embodiment relates to a catalyst system according to the invention which comprises at least one compound of the general formula (Z) and a catalyst (N) which has the general structural element (N1), where the carbon atom denoted by “*” is bound via one or more double bonds to the catalyst framework,

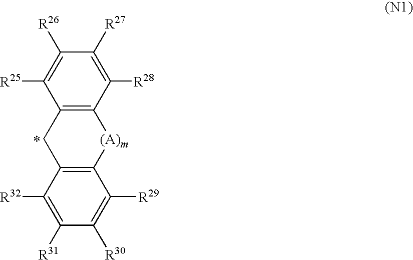

and where
R²⁵-R³² are identical or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃⁻), —OSO₃⁻, —PO₃⁻ or OPO₃⁻ or alkyl, cycloalkyl, alkenyl, alkynyl, aryl, carboxylate, alkoxy, alkenyloxy, alkynyloxy, aryloxy, alkoxycarbonyl, alkylamino, alkylthio, arylthio, alkylsulphonyl, alkylsulphinyl, dialkylamino, alkylsilyl or alkoxysilyl, where these radicals can each optionally be substituted by one or more alkyl, halogen, alkoxy, aryl or heteroaryl radicals, or, as an alternative, two directly adjacent radicals from the group consisting of R²⁵-R³² together with the ring carbons to which they are bound form a cyclic group, preferably an aromatic system, by bridging or, as an alternative, R⁸ is optionally bridged to another ligand of the ruthenium- or osmium-carbene complex catalyst,
m is 0 or 1 and
A is oxygen, sulphur, C(R³³R³⁴), N—R³⁵, —C(R³⁶)═C(R³⁷)—, —C(R³⁶)(R³⁸)—C(R³⁷)(R³⁹)-, where R³³-R³⁹ are identical or different and can each have the same meanings as the radicals R²⁵-R³².

The catalysts of the invention have the structural element of the general formula (N1), where the carbon atom denoted by “*” is bound via one or more double bonds to the catalyst framework. If the carbon atom denoted by “*” is bound via two or more double bonds to the catalyst framework, these double bonds can be cumulated or conjugated.

Such catalysts (N) have been described in the as yet unpublished German patent application number DE 102007039695, which is hereby incorporated by reference for the definition of the catalysts (N) and their preparation, insofar as this is permitted by the relevant jurisdictions.

The catalysts (N) having a structural element of the general formula (N1) include, for example, catalysts of the general formulae (N2a) and (N2b) below,

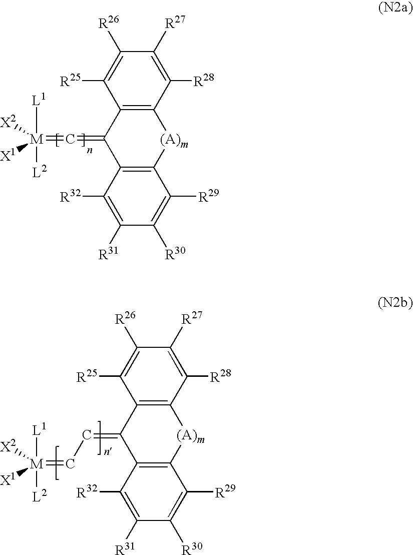

where
M is ruthenium or osmium,
X¹ and X² are identical or different and are two ligands, preferably anionic ligands,
L¹ and L² are identical or different ligands, preferably uncharged electron donors, where L² can alternatively also be bridged to the radical R⁸,
n is 0, 1, 2 or 3, preferably 0, 1 or 2,
n′ is 1 or 2, preferably 1, and
R²⁵-R³², m and A have the same meanings as in the general formula (N1).

In the catalysts of the general formula (N2a), the structural element of the general formula (N1) is bound via a double bond (n=0) or via 2, 3 or 4 cumulated double bonds (in the case of n=1, 2 or 3) to the central metal of the complex catalyst. In the catalysts according to the invention of the general formula (N2b), the structural element of the general formula (N1) is bound via conjugated double bonds to the metal of the complex catalyst. In both cases, the carbon atom denoted by “*” as a double bond in the direction of the central metal of the complex catalyst.

The catalysts of the general formulae (N2a) and (N2b) thus encompass catalysts in which the general structural elements (N3)-(N9)

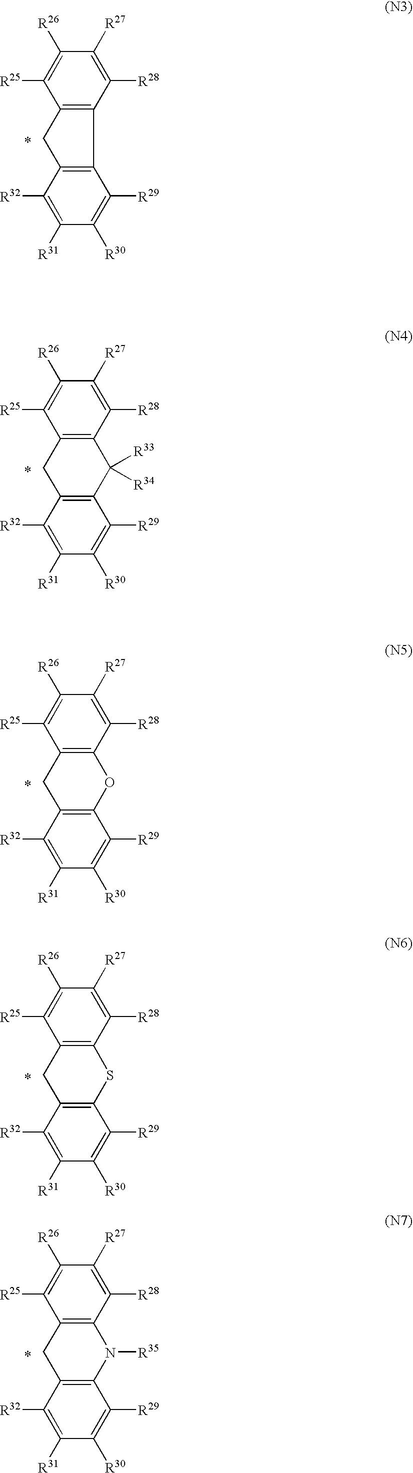

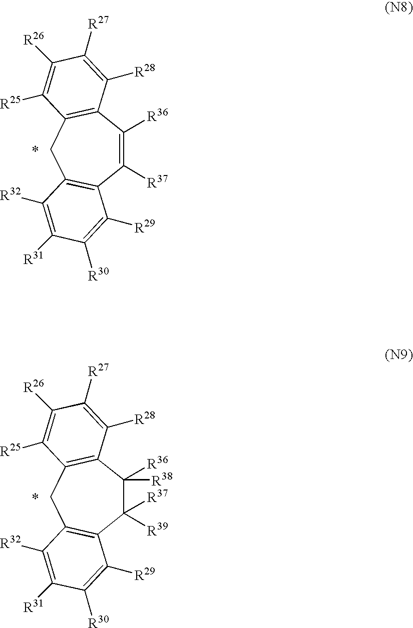

are bound via the carbon atom denoted by “*” via one or more double bonds to the catalyst framework of the general formula (N10a) or (N10b)

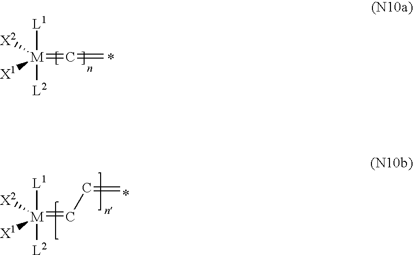

where X¹ and X², L¹ and L², n, n′ and R²⁵-R³⁹ have the meanings given for the general formulae (N2a) and (N2b).

The ruthenium- or osmium-carbene catalysts of the invention typically have five-fold coordination.

In the structural element of the general formula (N1),
R¹⁵-R³² are identical or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃⁻), —OSO₃⁻, —PO₃⁻ or OPO₃⁻ or alkyl, preferably C₁-C₁₀-alkyl, in particular C₁-C₆-alkyl, cycloalkyl, preferably C₃-C₂₀-cycloalkyl, in particular C₃-C₈-cycloalkyl, alkenyl, preferably C₂-C₂₀-alkenyl, alkynyl, preferably C₂-C₂₀-alkynyl, aryl, preferably C₆-C₂₄-aryl, in particular phenyl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, alkylsulphinyl, preferably C₁-C₂₀-alkylsulphinyl, dialkylamino, preferably di(C₁-C₂₀-alkyl)amino, alkylsilyl, preferably C₁-C₂₀-alkylsilyl, or alkoxysilyl, preferably C₁-C₂₀-alkoxysilyl, where these radicals can each be optionally substituted by one or more alkyl, halogen, alkoxy, aryl or heteroaryl radicals, or, as an alternative, in each case two directly adjacent radicals from the group consisting of R²⁵-R³² together with the ring carbons to which they are bound may also form a cyclic group, preferably an aromatic system, by bridging or, as an alternative, R⁸ is optionally bridged to another ligand of the ruthenium- or osmium-carbene complex catalyst,
m is 0 or 1 and
A is oxygen, sulphur, C(R³³)(R³⁴), N—R³⁵, —C(R³⁶)═C(R³⁷)— or —C(R³⁶)(R³⁸)—C(R³⁷)(R³⁹)—, where R³³-R³⁹ are identical or different and can each have the same preferred meanings as the radicals R¹-R⁸.

C₁-C₆-Alkyl in the structural element of the general formula (N1) is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl or n-hexyl.

C₃-C₈-Cycloalkyl in the structural element of the general formula (N1) is, for example, cyclopropyl, cyclobutyl, cylopentyl, cyclohexyl, cycloheptyl or cyclooctyl.

C₆-C₂₄-Aryl in the structural element of the general formula (N1) comprises an aromatic radical having from 6 to 24 skeletal carbon atoms. As preferred monocyclic, bicyclic or tricyclic carbocyclic aromatic radicals having from 6 to 10 skeletal carbon atoms, mention may be made by way of example of phenyl, biphenyl, naphthyl, phenanthrenyl or anthracenyl.

The radicals X¹ and X² in the structural element of the general formula (N1) have the same general, preferred and particularly preferred meanings indicated for catalysts of the general formula A.

In the general formulae (N2a) and (N2b) and analogously in the general formulae (N10a) and (N10b), the radicals L¹ and L² are identical or different ligands, preferably uncharged electron donors, and can have the same general, preferred and particularly preferred meanings indicated for catalysts of the general formula A.

Preference is given to catalysts of the general formulae (N2a) or (N2b) having a general structural unit (N1) in which
M is ruthenium,
X¹ and X² are both halogen,
n is 0, 1 or 2 in the general formula (N2a) or
n′ is 1 in the general formula (N2b)
L¹ and L² are identical or different and have the general or preferred meanings indicated for the general formulae (N2a) and (N2b),
R²⁵-R³² are identical or different and have the general or preferred meanings indicated for the general formulae (N2a) and (N2b),
m is either 0 or 1,
and, when m=1,
A is oxygen, sulphur, C(C₁-C₁₀-alkyl)₂, —C(C₁-C₁₀-alkyl)₂, —C(C₁-C₁₀-alkyl)₂-, —C(C₁-C₁₀-alkyl)=C(C₁-C₁₀-alkyl)- or —N(C₁-C₁₀-alkyl).

Very particular preference is given to catalysts of the general formulae (N2a) or (N2b) having a general structural unit (N1) in which
M is ruthenium,
X¹ and X² are both chlorine,
n is 0, 1 or 2 in the general formula (N2a) or
n′ is 1 in the general formula (N2b)
L¹ is an imidazolidine radical of one of the formulae (IIIa) to (IIIf),
L² is a sulphonated phosphine, phosphate, phosphinite, phosphonite, arsine, stibine, ether, amine, amide, sulphoxide, carboxyl, nitrosyl, pyridine radical, an imidazolidine radical of one of the formulae (XIIa) to (XIIf) or a phosphine ligand, in particular PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃,
R²⁵-R³² have the general or preferred meanings indicated for the general formulae (N2a) and (N2b),
m is either 0 or 1
and, when m=1,
A is oxygen, sulphur, C(C₁-C₁₀-alkyl)₂, —C(C₁-C₁₀-alkyl)₂, —C(C₁-C₁₀-alkyl)₂-, —C(C₁-C₁₀-alkyl)═C(C₁-C₁₀-alkyl)- or —N(C₁-C₁₀-alkyl).

When the radical R²⁵ is bridged to another ligand of the catalyst of the formula N, this results, for example for the catalysts of the general formulae (N2a) and (N2b), in the following structures of the general formulae (N13a) and (N13b)

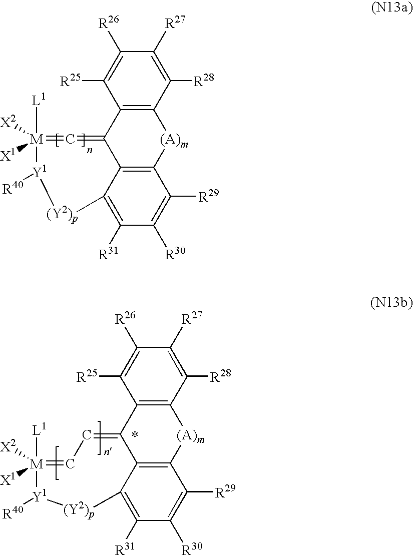

where
Y¹ is oxygen, sulphur, an N—R⁴¹ radical or a P—R⁴¹ radical, where R⁴¹ has the meanings indicated below,
R⁴⁰ and R⁴¹ are identical or different and are each an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical which may each be optionally substituted by one or more alkyl, halogen, alkoxy, aryl or heteroaryl radicals,
p is 0 or 1 and
Y² when p=1 is —(CH₂)ᵣ— where r=1, 2 or 3, —C(═O)—CH₂—, —C(═O)—, —N═CH—, —N(H)—C(═O)— or, as an alternative, the entire structural unit “-Y¹ (R⁴⁰)-(Y²)ₚ—” is (—N(R⁴⁰)═CH—CH₂—), (—N(R⁴⁰,R⁴¹)═CH—CH₂—), and)
where M, X¹, X², L¹, R²⁵-R³², A, m and n have the same meanings as in the general formulae (IIa) and (IIb)

As examples of catalysts of the formula (N), mention may be made of the following structures:

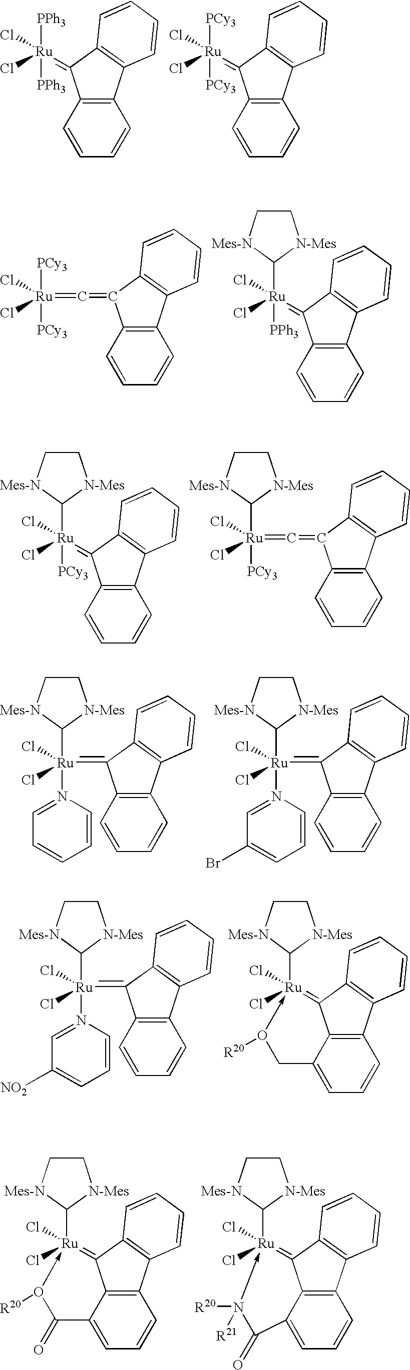

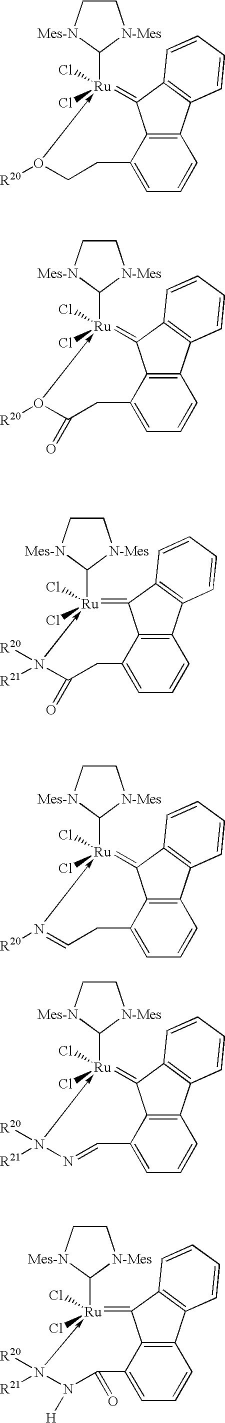

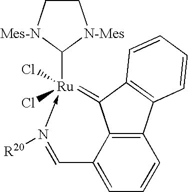

In a preferred embodiment, the catalysts having the abovementioned structural formulae together with at least one compound of the general formula (Z) form the catalyst system of the invention, where the radicals W in the compound of the formula (Z) are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

The preparation of catalysts (N) can be carried out by reacting suitable catalyst precursor complexes with suitable diazo compounds when this synthesis is carried out in a specific temperature range and at the same time the molar ratio of the starting materials to one another is in a selected region. For this purpose, a catalyst precursor compound is, for example, reacted with a compound of the general formula (N1-Azo)

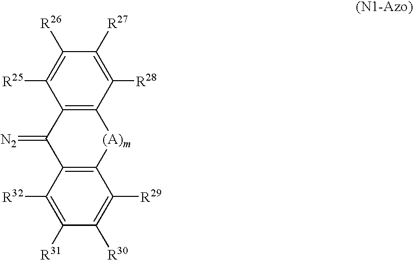

where R²⁵-R³², m and A have the meanings indicated for the general formula (N1), with the reaction being carried out
(i) at a temperature in the range from −20° C. to 100° C., preferably in the range from +10° C. to +80° C., particularly preferably in the range from +30 to +50° C., and
(ii) at a molar ratio of the catalyst precursor compound to the compound of the general formula (N1-Azo) of from 1:0.5 to 1:5, preferably from 1:1.5 to 1:2.5, particularly preferably 1:2.

The compounds of the general formula (N1-Azo) are 9-diazofluorene or various derivatives thereof, depending on the meaning of the radicals R²⁵-R³² and A. It is possible to use various derivatives of 9-diazofluorene. In this way, a variety of fluorenylidene derivatives can be obtained.

The catalyst precursor compounds are ruthenium or osmium complex catalysts which do not yet contain a ligand having the general structural element (N1).

In this reaction, a ligand leaves the catalyst precursor compound and is replaced by a carbene ligand containing the general structural element (N1).

Solvents suitable for carrying out the reaction are saturated, unsaturated and aromatic hydrocarbons, ethers and halogenated solvents. Preference is given to chlorinated solvents such as dichloromethane, 1,2-dichloroethane or chlorobenzene. The catalyst precursor compound is usually initially charged in the form of a ruthenium- or osmium precursor in a preferably dried solvent. The concentration of the ruthenium or osmium precursor in the solvent is usually in the range from 15 to 25% by weight, preferably in the range from 15 to 20% by weight. The solution can subsequently be heated. It has been found to be particularly useful to heat the solution to a temperature in the range from 30 to 50° C. The compound of the general formula (N1-Azo) dissolved in a usually dried, preferably water-free solvent is then added. The concentration of the compound of the general formula (N1-Azo) in the solvent is preferably in the range from 5 to 15% by weight, preferably about 10%. To complete the reaction, the mixture is left to react for another 0.5 h-1.5 h, particularly preferably at a temperature in the same range as mentioned above, i.e. from 30 to 50° C. The solvent is subsequently removed and the residue is purified by extraction, for example with a mixture of hexane with an aromatic solvent.

The catalyst of the invention is usually not obtained in pure form but as an equimolar mixture as per the stoichiometry of the reaction with the reaction product of the compound of the general formula (N1-Azo) with the leaving ligand of the catalyst precursor compound used in the reaction. The leaving ligand is preferably a phosphine ligand. This reaction product can be removed in order to obtain the pure catalyst according to the invention. However, the catalysis of metathesis reactions can be carried out using not only the pure catalyst according to the invention but also the mixture of this catalyst according to the invention with the abovementioned reaction product.

The above-described process is described in more detail below:

In the case of the catalysts of the general formulae (N2a) and (N2b), a catalyst precursor compound of the general formula (“N2 precursor”),

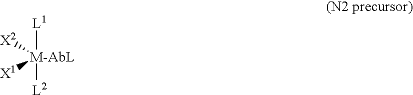

where
M, X¹, X², L¹ and L² have the same general and preferred meanings as in the general formulae (N2a) and (N2b) and
AbL is a “leaving ligand” and can have the same meanings as L¹ and L² in the general formulae (N2a) and (N2b), preferably a phosphine ligand having the meanings indicated for the general formulae (N2a) and (N2b),
   is reacted with a compound of the general formula (N1-Azo) at a temperature in the range from −20° C. to 100° C., preferably in the range from +10° C. to +80° C., particularly preferably in the range from +30 to +50° C., and at a molar ratio of the catalyst precursor compound of the general formula (XVII) to the compound of the general formula (N1-Azo) of from 1:0.5 to 1:5, preferably from 1:1.5 to 1:2.5, particularly preferably 1:2. Further examples of the preparation of such catalysts of the formula (N) are present in the as yet unpublished patent application DE 102007039695.

These catalyst systems preferably contain the catalyst of the general formula (N) together with a compound of the general formula (Z) in which the radicals R′ are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl or two or three radicals R′ are bridged and then in each case two radicals R′ together form an alkylene radical, particularly preferably an ethylene, n-propylene or n-butylene radical, an alkenylene radical or an alkynylene radical.

The present invention further provides for the use of the catalyst systems according to the invention in metathesis reactions. The metathesis reactions can be, for example, ring-closing metatheses (RCM), cross metatheses (CM) or ring-opening metatheses (ROMP). For this purpose, the compound or compounds to be subjected to the metathesis is/are brought into contact and reacted with the catalyst system of the invention.

In the catalyst system according to the invention, the metathesis catalyst and the compound of the general formula (Z) are used in a molar ratio of [metathesis catalyst:compound of the general formula (Z)]=1:(0.1-1000) for example, preferably 1:(0.5-100) and particularly preferably 1:(1-50).

As solvent or dispersion medium in which the compound of the general formula (Z) is added to the complex catalyst or its solution, it is possible to use all known solvents or dispersion media. For the addition of the compound of the general formula (Z) to be effective, it is not necessary for the compound of the general formula (Z) to have a solubility in the dispersion medium. Preferred solvents or dispersion media encompass, but are not restricted to, acetone, benzene, chlorobenzene, chloroform, cyclohexane, dichloromethane, diethyl ether, dioxane, dimethylformamide, dimethylacetamide, dimethyl sulphone, dimethyl sulphoxide, methyl ethyl ketone, tetrahydrofuran, tetrahydropyran and toluene. The solvent or dispersion medium is preferably inert towards the complex catalyst.

The catalyst systems according to the invention are preferably used for the metathesis of nitrile rubber. The use according to the invention is then a process for reducing the molecular weight of nitrile rubber by bringing the nitrile rubber into contact with the catalyst system according to the invention. This reaction is a cross metathesis.

When the catalyst systems according to the invention are used for the metathesis of nitrile rubber, the amount in which the compound of the general formula (Z) is used is, based on the nitrile rubber to be degraded, in the range from 0.0001 phr to 5 phr, preferably from 0.001 phr to 2 phr (phr=parts by weight per 100 parts by weight of rubber).

For use in the metathesis of NBR, the compound of the general formula (Z) can also be added in a solvent or dispersant or without a solvent or dispersant to a solution of the complex catalyst. As an alternative, the compound of the general formula (Z) can also be added directly to a solution of the nitrile rubber to be degraded to which the complex catalyst is then also added so that the entire catalyst system according to the invention is present in the reaction mixture.

The amount of complex catalyst based on the nitrile rubber used depends on the nature and the catalytic activity of the specific complex catalyst. The amount of complex catalyst used is usually from 1 to 1000 ppm of noble metal, preferably from 2 to 500 ppm, in particular from 5 to 250 ppm, based on the nitrile rubber used.

The NBR metathesis can be carried out in the absence or in the presence of a coolefin. This is preferably a straight-chain or branched C₂-C₁₆-olefin. Suitable olefins are, for example, ethylene, propylene, isobutene, styrene, 1-hexene and 1-octene. Preference is given to using 1-hexene or 1-octene. If the coolefin is liquid (for example as in the case of 1-hexene), the amount of coolefin is preferably in the range 0.2-20% by weight based on the NBR used. If the coolefin is a gas, for example as in the case of ethylene, the amount of coolefin is preferably selected so that a pressure in the range 1×10⁵ Pa-1×10⁷ Pa, preferably a pressure in the range from 5.2×10⁵ Pa to 4×10⁶ Pa, is established in the reaction vessel at room temperature.

The metathesis reaction can be carried out in a suitable solvent which does not deactivate the catalyst used and also does not adversely affect the reaction in any other way. Preferred solvents encompass, but are not restricted to, dichloromethane, benzene, toluene, methyl ethyl ketone, acetone, tetrahydrofuran, tetrahydropyran, dioxane, cyclohexane and chlorobenzene. The particularly preferred solvent is chlorobenzene. In some case, when the coolefin itself can act as solvent, e.g. in the case of 1-hexene, the addition of a further additional solvent can also be dispensed with.

The concentration of the nitrile rubber used in the reaction mixture of the metathesis is not critical, but it naturally has to be noted that the reaction should not be adversely affected by an excessively high viscosity of the reaction mixture and the mixing problems associated therewith. The concentration of the NBR in the reaction mixture is preferably in the range from 1 to 25% by weight, particularly preferably in the range from 5 to 20% by weight, based on the total reaction mixture.

The metathetic degradation is usually carried out at a temperature in the range from 10° C. to 150° C., preferably at a temperature in the range from 20 to 100° C.

The reaction time depends on a number of factors, for example on the type of NBR, on the type of catalyst, on the catalyst concentration employed and on the reaction temperature. The reaction is typically complete within five hours under normal conditions. The progress of the metathesis can be monitored by standard analytical methods, e.g. by GPC measurements or by determination of the viscosity.

As nitrile rubbers (“NBR”), it is possible to use copolymers or terpolymers which contain repeating units of at least one conjugated diene, at least one α,β-unsaturated nitrile and, if appropriate, one or more further copolymerizable monomers in the metathesis reaction.

The conjugated diene can be of any nature. Preference is given to using (C₄-C₆)-conjugated dienes. Particular preference is given to 1,3-butadiene, isoprene, 2,3-dimethylbutadiene, piperylene or mixtures thereof. In particular, use is preferably made of 1,3-butadiene or isoprene or mixtures thereof. Very particular preference is given to 1,3-butadiene.

As α,β-unsaturated nitrile, it is possible to use any known α,β-unsaturated nitrile, with preference being given to (C₃-C₅)-α,β-unsaturated nitriles such as acrylonitrile, methacrylonitrile, ethacrylonitrile or mixtures thereof. Particularly preference is given to acrylonitrile.

A particularly preferred nitrile rubber is thus a copolymer of acrylonitrile and 1,3-butadiene.

In addition to the conjugated diene and the α,β-unsaturated nitrile, it is possible to use one or more further copolymerizable monomers known to those skilled in the art, e.g. α,β-unsaturated monocarboxylic or dicarboxylic acids, their esters or amides. As α,β-unsaturated monocarboxylic or dicarboxylic acids, preference is given to fumaric acid, maleic acid, acrylic acid and methacrylic acid. As esters of α,β-unsaturated carboxylic acids, preference is given to using their alkyl esters and alkoxyalkyl esters. Particularly preferred alkyl esters of α,β-unsaturated carboxylic acids are methyl acrylate, ethyl acrylate, butyl acrylate, butyl methacrylate, 2-ethylhexyl acrylate, 2-ethylhexyl methacrylate and octyl acrylate. Particularly preferred alkoxyalkyl esters of α,β-unsaturated carboxylic acids are methoxyethyl (meth)acrylate, ethoxyethyl (meth)acrylate and methoxyethyl (meth)acrylate. It is also possible to use mixtures of alkyl esters, e.g. those mentioned above, with alkoxyalkyl esters, e.g. in the form of those mentioned above.

The proportions of conjugated diene and α,β-unsaturated nitrile in the NBR polymers to be used can vary within wide ranges. The proportion of the conjugated diene or the sum of conjugated dienes is usually in the range from 40 to 90% by weight, preferably in the range from 60 to 85% by weight, based on the total polymer. The proportion of the α,β-unsaturated nitrile or the sum of the α,β-unsaturated nitriles is usually from 10 to 60% by weight, preferably from 15 to 40% by weight, based on the total polymer. The proportions of the monomers in each case add up to 100% by weight. The additional monomers can be present in amounts of from 0 to 40% by weight, preferably from 0.1 to 40% by weight, particularly preferably from 1 to 30% by weight, based on the total polymer. In this case, corresponding proportions of the conjugated diene or dienes and/or the α,β-unsaturated nitrile or nitriles are replaced by the proportions of the additional monomers, with the proportions of all monomers in each case adding up to 100% by weight.

The preparation of nitrile rubbers by polymerization of the abovementioned monomers is adequately known to those skilled in the art and is comprehensively described in the literature.

Nitrile rubbers which can be used for the purposes of the invention are also commercially available, e.g. as products from the product range of the grades Perbunan® and Krynac® of Lanxess Deutschland GmbH.

The nitrile rubbers used for the metathesis have a Mooney viscosity (ML 1+4 at 100° C.) in the range from 30 to 70, preferably from 30 to 50. This corresponds to a weight average molecular weight M_{w} in the range 150 000-500 000, preferably in the range 180 000-400 000. Furthermore, the nitrile rubbers used have a polydispersity PDI=M_{w}/Mₙ, where M_{w} is the weight average molecular weight and Mₙ is the number average molecular weight, in the range 2.0-6.0 and preferably in the range 2.0-4.0.

The determination of the Mooney viscosity is carried out in accordance with ASTM standard D 1646.

The nitrile rubbers obtained by the metathesis process of the invention have a Mooney viscosity (ML 1+4 at 100° C.) in the range 5-30, preferably in the range 5-20. This corresponds to a weight average molecular weight M_{w} in the range 10 000-100 000, preferably in the range 10 000-80 000. Furthermore, the nitrile rubbers obtained have a polydispersity PDI=M_{w}/Mₙ, where Mₙ, is the number average molecular weight, in the range 1.4-4.0, preferably in the range 1.5-3.0.

The metathetic degradation in the presence of the catalyst system according to the invention can be followed by a hydrogenation of the degraded nitrile rubbers obtained. This can be carried out in the manner known to those skilled in the art.

The hydrogenation can be carried out using homogeneous or heterogeneous hydrogenation catalysts. It is also possible to carry out the hydrogenation in situ, i.e. in the same reaction mixture in which the metathetic degradation has previously taken place and without the need to isolate the degraded nitrile rubber. The hydrogenation catalyst is simply introduced into the reaction vessel.

The catalysts used are usually based on rhodium, ruthenium or titanium, but it is also possible to use platinum, iridium, palladium, rhenium, ruthenium, osmium, cobalt or copper either as metal or preferably in the form of metal compounds (see, for example, U.S. Pat. No. 3,700,637, DE-A-25 39 132, EP-A-0 134 023, DE-OS-35 41 689, DE-A-35 40 918, EP-A-0 298 386, DE-A-35 29 252, DE-A-34 33 392, U.S. Pat. No. 4,464,515 and U.S. Pat. No. 4,503,196).

Suitable catalysts and solvents for a hydrogenation in the homogeneous phase are described below and are also known from DE-A-25 39 132 and EP-A-0 471 250.

The selective hydrogenation can, for example, be achieved in the presence of a rhodium- or ruthenium-containing catalyst. It is possible to use, for example, a catalyst of the general formula

(Rₘ¹,BP)₁MXₙ

where M is ruthenium or rhodium, the radicals R¹ are identical or different and are each a C₁-C₈-alkyl group, a C₄-C₈-cycloalkyl group, a C₆-C₁₅-aryl group or a C₇-C₁₅-aralkyl group. B is phosphorus, arsenic, sulphur or a sulphoxide group S═O, X is hydrogen or an anion, preferably halogen and particularly preferably chlorine or bromine, 1 is 2, 3 or 4, m is 2 or 3 and n is 1, 2 or 3, preferably 1 or 3. Preferred catalysts are tris(triphenylphosphine)rhodium(I) chloride, tris(triphenylphosphine)rhodium(1H) chloride and tris(dimethyl sulphoxide)rhodium(III) chloride and also tetrakis(triphenylphosphine)rhodium hydride of the formula (C₆H₅)₃P)₄RhH and the corresponding compounds in which all or part of the triphenylphosphine has been replaced by tricyclohexylphosphine. The catalyst can be used in small amounts. An amount in the range 0.01-1% by weight, preferably in the range 0.03-0.5% by weight and particularly preferably in the range 0.05-0.3% by weight, based on the weight of the polymer, is suitable.

It is usually useful to use the catalyst together with a cocatalyst which is a ligand of the formula Rₘ¹B, where R¹, m and B are as defined above for the catalyst. Preference is given to m being 3, B being phosphorus and the radicals R¹ can be identical or different. The cocatalysts preferably have trialkyl, tricycloalkyl, triaryl, triaralkyl, diarylmonoalkyl, diarylmonocycloalkyl, dialkylmonoaryl, dialkylmonocycloalkyl, dicycloalkylmonoaryl or dicycloalkylmonoaryl radicals.

Examples of cocatalysts may be found, for example, in U.S. Pat. No. 4,631,315. A preferred cocatalyst is triphenylphosphine. The cocatalyst is preferably used in amounts in the range 0.1-5% by weight, preferably in the range 0.3-4% by weight, based on the weight of the nitrile rubber to be hydrogenated. Furthermore, the weight ratio of the rhodium-containing catalyst to the cocatalyst is preferably in the range from 1:1 to 1:55, particularly preferably in the range from 1:3 to 1:45. Based on 100 parts by weight of the nitrile rubber to be hydrogenated, it is appropriate to use from 0.1 to 33 parts by weight of the cocatalyst, preferably from 0.5 to 20 parts by weight and very particularly preferably from 1 to 5 parts by weight, in particular more than 2 but less than 5 parts by weight, of cocatalyst.

The practical procedure for carrying out this hydrogenation is adequately known to those skilled in the art from U.S. Pat. No. 6,683,136. The nitrile rubber to be hydrogenated is usually treated in a solvent such as toluene or monochlorobenzene with hydrogen at a temperature in the range from 100 to 150° C. and a pressure in the range from 50 to 150 bar for from 2 to 10 hours.

For the purposes of the present invention, hydrogenation is a reaction of at least 50%, preferably 70-100%, particularly preferably 80-100%, of the double bonds present in the starting nitrile rubber. Particular preference is also given to residual contents of double bonds in the HNBR of from 0 to 8%.

When heterogeneous catalysts are used, these are usually supported catalysts based on palladium which are supported, for example, on carbons, silica, calcium carbonate or barium sulphate.

After the hydrogenation is complete, a hydrogenated nitrile rubber having a Mooney viscosity (ML 1+4 @ 100° C.), measured in accordance with ASTM standard D 1646, in the range 1-50 is obtained. This corresponds approximately to a weight average molecular weight M_{w} in the range 2000-400 000 g/mol. Preferably the Mooney viscosity (ML 1+4 @ 100° C.) is in the range from 5 to 30. This corresponds approximately to a weight average molecular weight M_{w} in the range of about 20 000-200 000. Furthermore, the hydrogenated nitrile rubbers obtained have a polydispersity PDI=M_{w}/Mₙ, where M_{w} is the weight average molecular weight and Mₙ is the number average molecular weight, in the range 1-5 and preferably in the range 1.5-3.

However, the catalyst system according to the invention can be used successfully not only for the metathetic degradation of nitrile rubbers but also universally for other metathesis reactions. In a ring-closing metathesis process, the catalyst system according to the invention is brought into contact with the appropriate acyclic starting material, e.g. diethyl diallylmalonate.

The use of the catalyst systems according to the invention comprising metathesis catalyst and the boric acid ester of the general formula (Z) enables, at comparable reaction times, the amount of the actual metathesis catalyst and thus the amount of noble metal to be significantly reduced compared to analogous metathesis reactions in which only the catalyst, i.e. without addition of a boric acid ester of the general formula (Z), is used. When comparable noble metal contents are used, the reaction time is substantially shortened by addition of the boron compound of the general formula (Z). When the catalyst systems are used for the degradation of nitrile rubbers, degraded nitrile rubbers having significantly lower molecular weights M_{w} and Mₙ can be obtained. It is important to the efficiency of the metathesis reaction that boric esters B(OR′)₃ of the general formula Z are used. Even replacement of an “OR′” radical by a radical “R′” reduces the catalyst efficiency and leads to a decreased metathetic degradation, as demonstrated in the examples.

### Examples

When the following examples are carried out at room temperature, this is 22 +/−2° C.

The complex catalysts shown in Table 1 were used in the examples.

| | | Molecular | |
|---|---|---|---|
| Name of | | weight | |
| catalyst | Structural formula | [g/mol] | Source |
| Grubbs II catalyst | 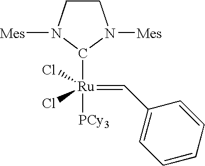 | 848.33 | Materia/ Pasadena; USA |
| Hoveyda catalyst | 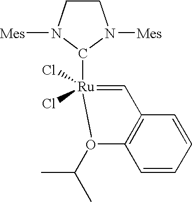 | 626.14 | Aldrich |

The following boron-containing additives were used in the experiments:

| Identity of additive | | Formula | Source |
|---|---|---|---|
| B(Isopropoxide)₃ | B(OiPr)₃ | B(—O—CH(CH₃)₂)₃ | Acros Organics |
| B(Isopropoxide)₂(methyl) | B(iPr)₂Me | B(—O—CH(CH₃)₂)₂(CH₃) | Acros Organics |
| B(n-butoxide)₃ | B(OnBu)₃ | B(—O—CH₂)₃—CH₃)₃ | Aldrich |

Overview of the experiments carried out on the degradation of NBR:

| | | | | Molar ratio |
|---|---|---|---|---|
| Trial | | Catalyst | Additive | (catalyst:additive) |
| 1.0 | Comparative example | Grubbs II | — | — |
| 1.1 | Example according to the invention | Grubbs II | B(isopropoxide)₃ | 1:22 |
| 1.2 | Comparative example | Grubbs II | B(isopropoxide)₂(methyl) | 1:22 |
| 1.3 | Example according to the invention | Grubbs II | B(n-butoxide)₃ | 1:22 |
| 2.0 | Comparative example | Hoveyda | — | — |
| 2.1 | Example according to the invention | Hoveyda | B(isopropoxide)₃ | 1:2 |

Nitrile rubber used:

The degradation reactions described in the following trials were carried out using the nitrile rubber Perbunan® 3436 F from Lanxess Deutschland GmbH. This nitrile rubber has the following characteristic properties:

| Acrylonitrile content: | 34.3% by weight |
|---|---|
| Mooney viscosity (ML 1 + 4 @ 100° C.): | 33 Mooney units |
| Residual moisture content: | 1.0% by weight |
| M_{w}: | 211 kg/mol |
| Mₙ: | 82 kg/mol |
| PDI (M_{w}/Mₙ): | 2.6 |

Procedure for the metathesis:

The metathetic degradation was in each case carried out using 293.3 g of chlorobenzene (hereinafter referred to as “MCB”/from Aldrich) which had been distilled and made inert at room temperature by passing argon through it before use. 40 g of NBR were dissolved therein at room temperature over a period of 12 hours while stirring. 0.8 g (2 phr) of 1-hexene was in each case added to the NBR-containing solution and the boron compound indicated in the table (dissolved in 10 g of inertized MCB) was then added and the mixture was homogenized by stirring for 30 minutes.

The Ru catalysts (Grubbs II and Hoveyda catalyst) were in each case dissolved in 10 g of inertized MCB under argon, with the addition of the catalyst solutions to the NMR solutions in MCB being carried out immediately after the preparation of the catalyst solutions.

The metathesis reactions were carried out using the amounts of starting materials indicated in the following tables at room temperature.

After the reaction times indicated in the tables, about 3 ml were in each case taken from the reaction solutions and immediately admixed with about 0.2 ml of ethyl vinyl ether to stop the reaction. 0.2 ml was taken from the stopped solution and diluted with 3 ml of DMAc (N,N-dimethylacetamide (stabilized with LiBr, 0.075M) from Aldrich).

Before carrying out the GPC analysis, the solutions were in each case filtered by means of a 0.2 μm syringe filter made of Teflon (Chromafil PTFE 0.2 mm; from Machery-Nagel). The GPC analysis was then carried out using an instrument from Waters (model 510). The analysis was carried out using a combination of a precolumn (PL Guard from Polymer Laboratories) with 2 Resipore columns (300×7.5 mm, pore size: 3 μm) from Polymer Laboratories. Calibration of the columns was carried out using linear polystyrene having molar masses of from 960 to 6×10⁵ g/mol from Polymer Standards Services. An RI detector from Waters (Waters 410 differential refractometer) was used as detector. The analysis was carried out at a flow rate of 1.0 ml/min at 80° C. using N,N′-dimethylacetamide as eluent. The GPC curves were evaluated using software from Polymer Laboratories (Cirrus Multi Version 3.0).

### Trial 1:

Use of the Grubbs II catalyst in combination with various boron-containing additives in the metathetic degradation of NBR

### Experiment 1.0:

Use of the Grubbs II catalyst without additive (comparative example)

| | Grubbs II | | | | | |
|---|---|---|---|---|---|---|
| | catalyst | | 1-Hexene | | | |
| | | based | | based | | |
| NBR | | on | | on | Additive | |
| Amount | Amount | NBR | Amount | NBR | | Amount |
| [g] | [mg] | [phr] | [g] | [phr] | Type | [mg] |
| 40 | 20 | 0.05 | 0.8 | 2.0 | — | — |

| Time | M_{w} | Mₙ | |
|---|---|---|---|
| [min.] | [kg/mol] | [kg/mol] | PDI |
| 0 | 211 | 82 | 2.6 |
| 30 | 139 | 66 | 2.1 |
| 60 | 101 | 54 | 1.9 |
| 185 | 77 | 45 | 1.7 |
| 425 | 62 | 37 | 1.7 |

### Experiment 1.1:

Use of the Grubbs II catalyst in combination with B(isopropoxide)₃ (Molar ratio of (Grubbs II:B(isopropoxide)₃)=1:22 (example according to the invention)

| | Grubbs II | | | | | |
|---|---|---|---|---|---|---|
| | catalyst | | 1-Hexene | | | |
| | | based | | based | | |
| NBR | | on | | on | Additive | |
| Amount | Amount | NBR | Amount | NBR | | Amount |
| [g] | [mg] | [phr] | [g] | [phr] | Type | [mg] |
| 40 | 20 | 0.05 | 0.8 | 2.0 | B(isopropoxide)₃ | 98 |

| Time | M_{w} | Mₙ | |
|---|---|---|---|
| [min.] | [kg/mol] | [kg/mol] | PDI |
| 0 | 211 | 82 | 2.6 |
| 30 | 109 | 53 | 2.1 |
| 60 | 72 | 39 | 1.9 |
| 185 | 40 | 21 | 1.9 |
| 425 | 26 | 13 | 2.0 |

### Experiment 1.2:

Use of the Grubbs II catalyst in combination with B(isopropoxide)₂(methyl) (Molar ratio of (Grubbs II:B(isopropoxide)₂(methyl)=1:22 (comparative example)

| | Grubbs II | | | | | |
|---|---|---|---|---|---|---|
| | catalyst | | 1-Hexene | | | |
| | | based | | based | | |
| NBR | | on | | on | Additive | |
| Amount | Amount | NBR | Amount | NBR | | Amount |
| [g] | [mg] | [phr] | [g] | [phr] | Type | [mg] |
| 40 | 20 | 0.05 | 0.8 | 2.0 | B(OiPr)₂ME | 75 |

| Time | M_{w} | Mₙ | |
|---|---|---|---|
| [min.] | [kg/mol] | [kg/mol] | PDI |
| 0 | 211 | 82 | 2.6 |
| 30 | 180 | 68 | 2.6 |
| 60 | 118 | 61 | 1.9 |
| 185 | 85 | 48 | 1.8 |
| 365 | 75 | 43 | 1.8 |
| 1385 | 73 | 42 | 1.7 |

### Experiment 1.3:

Use of the Grubbs II catalyst in combination with B(n-butoxide)₃ (Molar ratio of (Grubbs II: B(n-butoxide)₃)=1:22) (example according to the invention)

| | Grubbs II | | | | | |
|---|---|---|---|---|---|---|
| | catalyst | | 1-Hexene | | | |
| | | based | | based | | |
| NBR | | on | | on | Additive | |
| Amount | Amount | NBR | Amount | NBR | | Amount |
| [g] | [mg] | [phr] | [g] | [phr] | Type | [mg] |
| 40 | 20 | 0.05 | 0.8 | 2.0 | B(OnBu)₃ | 119 |

| Time | M_{w} | Mₙ | |
|---|---|---|---|
| [min.] | [kg/mol] | [kg/mol] | PDI |
| 0 | 211 | 82 | 2.6 |
| 30 | 77 | 34 | 2.2 |
| 60 | 41 | 21 | 1.9 |
| 185 | 30 | 15 | 2.1 |
| 425 | 22 | 11 | 1.9 |

### Trial 2:

Use of the Hoveyda catalyst in combination with triisopropyl borate in the metathetic degradation of NBR

### Experiment 2.0:

Use of the Hoveyda catalyst without additive (comparative example)

| | Hoveyda | | | | | |
|---|---|---|---|---|---|---|
| | catalyst | | 1-Hexene | | | |
| | | based | | based | | |
| NBR | | on | | on | Additive | |
| Amount | Amount | NBR | Amount | NBR | | Amount |
| [g] | [mg] | [phr] | [g] | [phr] | Type | [g] |
| 40 | 8 | 0.02 | 0.8 | 2.0 | — | — |

| Time | M_{w} | Mₙ | |
|---|---|---|---|
| [min.] | [kg/mol] | [kg/mol] | PDI |
| 0 | 211 | 82 | 2.6 |
| 30 | 100 | 48 | 2.1 |
| 60 | 83 | 43 | 1.9 |
| 185 | 86 | 48 | 1.8 |
| 425 | 82 | 47 | 1.7 |

### Experiment 2.1

Use of the Hoveyda catalyst in combination with B(isopropoxide)₃ Molar ratio of (Hoveyda catalyst:B(isopropoxide)₃)=1:2 (example according to the invention)

| | Hoveyda | | | | | |
|---|---|---|---|---|---|---|
| | catalyst | | 1-Hexene | | | |
| | | based | | based | | |
| NBR | | on | | on | Additive | |
| Amount | Amount | NBR | Amount | NBR | | Amount |
| [g] | [mg] | [phr] | [g] | [phr] | Type | [g] |
| 40 | 8 | 0.02 | 0.8 | 2.0 | B(isopropoxide)₃ | 4.8 |

| Time | M_{w} | Mₙ | |
|---|---|---|---|
| [min.] | [kg/mol] | [kg/mol] | PDI |
| 0 | 211 | 82 | 2.6 |
| 30 | 63 | 31 | 2.0 |
| 60 | 63 | 34 | 1.9 |
| 185 | 64 | 35 | 1.9 |
| 425 | 59 | 30 | 2.0 |

What is claimed is:

1. A catalyst system comprising a metathesis catalyst which is a complex catalyst based on molydenum, osmium or ruthenium and has at least one ligand bound in a carbene-like fashion to the metal and also at least one compound of the general formula (Z)
B(OR′)₃ (Z)
where
the radicals R′ are identical or different and are alkyl, cycloalkyl, alkenyl, allyl, alkynyl, aryl or heteroaryl radicals, where the heteroaryl radicals have at least one heteroatom, preferably nitrogen or oxygen, or R′ is a radical of the general formula (—CHZ¹—CHZ¹-A²-)ₚ—CH₂—CH₃, where p is an integer from 1 to 10, the radicals Z¹ are identical or different and are each hydrogen or methyl, with the radicals Z¹ located on adjacent carbon atoms preferably being different, and A² is oxygen, sulphur or —NH, or else two or three radicals R′ can be bridged to one another.

2. The catalyst system according to claim 1, wherein compounds of the general formula (A), 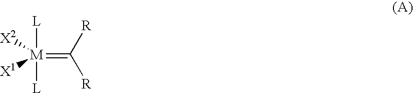
where
M is osmium or ruthenium,
X¹ and X² are identical or different and are two ligands,
the symbols L represent identical or different ligands,
the radicals R are identical or different and are each hydrogen, an alkyl, cycloalkyl, alkenyl, alkynyl, aryl, carboxylate, alkoxy, alkenyloxy, alkynyloxy, aryloxy, alkoxycarbonyl, alkylamino, alkylthio, arylthio, alkylsulphonyl, or alkylsulphinyl radical, which may in each case be substituted by one or more alkyl, halogen, alkoxy, aryl or heteroaryl radicals or, as an alternative, the two radicals R together with the common carbon atom to which they are bound are bridged to form a cyclic group which can be aliphatic or aromatic in nature, may be substituted and may contain one or more heteroatoms,
are used as catalyst.

3. The catalyst system according to claim 2, wherein X¹ and X² are identical or different and are each hydrogen, halogen, pseudohalogen, straight-chain or branched C₁-C₃₀-alkyl, C₆-C₂₄-aryl, C₁-C₂₀-alkoxy, C₆-C₂₄-aryloxy, C₃-C₂₀-alkyldiketonate, C₆-C₂₄-aryldiketonate, C₁-C₂₀-carboxylate, C₁-C₂₀-alkylsulphonate, C₆-C₂₄-arylsulphonate, C₁-C₂₀-alkylthiol, C₆-C₂₄-arylthiol, C₁-C₂₀-alkylsulphonyl or C₁-C₂₀-alkylsulphinyl radicals.

4. The catalyst system according to claim 2, wherein X¹ and X² are identical or different and are each halogen, benzoate, C₁-C₅-carboxylate, C₁-C₅-alkyl, phenoxy, C₁-C₅-alkoxy, C₁-C₅-alkylthiol, C₆-C₂₄-arylthiol, C₆-C₂₄-aryl or C₁-C₅-alkylsulphonate.

5. The catalyst system according to claim 2, wherein X¹ and X² are identical and are each fluorine, chlorine, bromine or iodine, CF₃COO, CH₃COO, CFH₂COO, (CH₃)₃CO, (CF₃)₂(CH₃)CO, (CF₃)(CH₃)₂CO, PhO (phenoxy), MeO (methoxy), EtO (ethoxy), tosylate (p-CH₃—C₆H₄—SO₃), mesylate (2,4,6-trimethylphenyl) or CF₃SO₃ (trifluoromethane-sulphonate).

6. The catalyst system according to claim 2, wherein the two ligands L are each, independently of one another, a phosphine, sulphonated phosphine, phosphate, phosphinite, phosphonite, arsine, stibine, ether, amine, amide, sulphoxide, carboxyl, nitrosyl, pyridine, thioether or imidazolidine (“Im”) ligand.

7. The catalyst system according to claim 6, wherein the imidazolidine radical (Im) has a structure of the general formula (IIa) or (IIb) 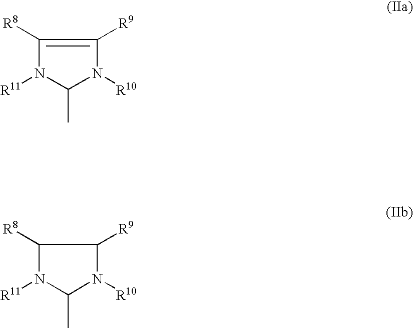
where
R⁸, R⁹, R¹⁰, R¹¹ are identical or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₀-aryloxy, C₂-C₂₀-alkoxycarbonyl, C₁-C₂₀-alkylthio, C₆-C₂₀-arylthio, C₁-C₂₀-alkylsulphonyl, C₁-C₂₀-alkylsulphonate, C₆-C₂₀-arylsulphonate or C₁-C₂₀-alkylsulphinyl where all the above radicals may be substituted.

8. The catalyst system according to claim 1, wherein catalysts of the general formula (A1), 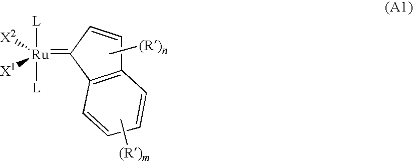
where
X¹ and X² are identical or different and are two ligands,
the symbols L represent identical or different ligands,
n is 0, 1 or 2,
m is 0, 1, 2, 3 or 4 and
the radicals R′ are identical or different and are alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals which may in each case be substituted by one or more alkyl, halogen, alkoxy, aryl or heteroaryl radicals,
are used.

9. The catalyst system according to claim 1, wherein the catalyst has the structure (IV), (V) or (VI), where Cy is in each case cyclohexyl, Mes is 2,4,6-trimethylphenyl and Ph is phenyl.

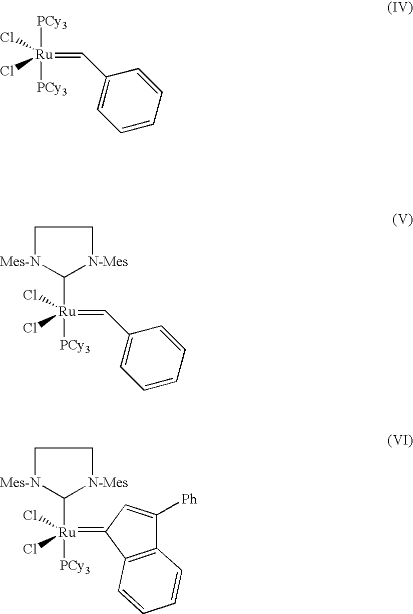

10. The catalyst system according to claim 1, wherein catalysts of the general formula (B), 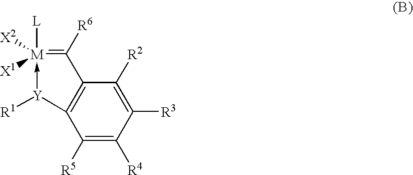
where
M is ruthenium or osmium,
Y is oxygen (O), sulphur (S), an N—R¹ radical or a P—R¹ radical,
X¹ and X² are identical or different ligands,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical which may in each case optionally be substituted by one or more alkyl, halogen, alkoxy, aryl or heteroaryl radicals,
R², R³, R⁴ and R⁵ are identical or different and are each hydrogen or an organic or inorganic radical,
R⁶ is hydrogen or an alkyl, alkenyl, alkynyl or aryl radical and
L is a phosphine, sulphonated phosphine, phosphate, phosphinite, phosphonite, arsine, stibine, ether, amine, amide, sulphoxide, carboxyl, nitrosyl, pyridine, thioether or imidazolidine (“Im”) ligand.
are used.

11. The catalyst system according to claim 10, wherein L is a P(R⁷)₃ radical, where the radicals R⁷ are each, independently of one another, C₁-C₆-alkyl, C₃-C₈-cycloalkyl or aryl, or else is a substituted or unsubstituted imidazolidine radical (“Im”) which preferably has the structure of one of the general formulae (IIa) and (IIb) mentioned in claim 7 and particularly preferably one of the following structures (IIIa) to (IIIf), where Mes is in each case a 2,4,6-trimethylphenyl radical or alternatively in each case a 2,6-diisopropylphenyl radical.

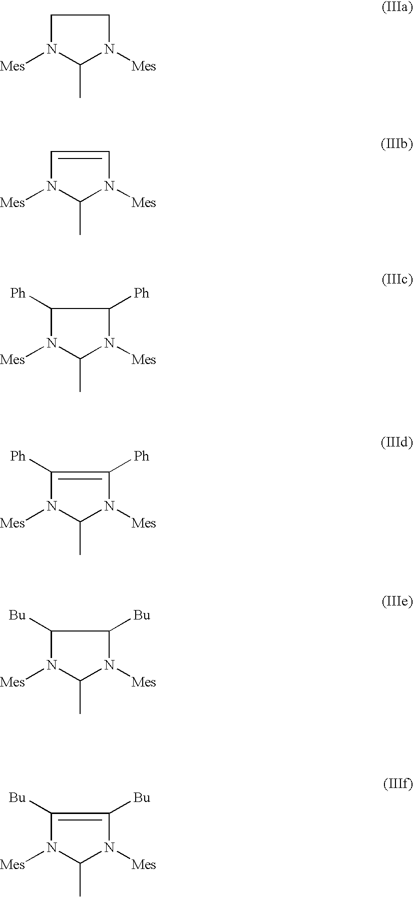

12. The catalyst system according to claim 10 or 11, wherein X¹ and X² in the general formula (B) are identical and are each fluorine, chlorine, bromine or iodine, CF₃COO, CH₃COO, CFH₂COO, (CH₃)₃CO, (CF₃)₂(CH₃)CO, (CF₃)(CH₃)₂CO, PhO (phenoxy), MeO (methoxy), EtO (ethoxy), tosylate (p-CH₃—C₆H₄—SO₃), mesylate (2,4,6-trimethylphenyl) or CF₃SO₃ (trifluoromethane-sulphonate).

13. The catalyst system according to claim 1, wherein catalysts of the general formula (B1), 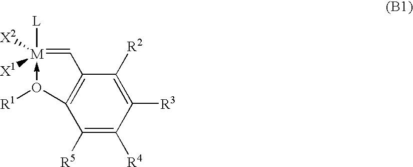
where
M is ruthenium or osmium,
X¹ and X² are identical or different ligands,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical which may in each case optionally be substituted by one or more alkyl, halogen, alkoxy, aryl or heteroaryl radicals,
R², R³, R⁴ and R⁵ are identical or different and are each hydrogen or an organic or inorganic radical, and
L is a phosphine, sulphonated phosphine, phosphate, phosphinite, phosphonite, arsine, stibine, ether, amine, amide, sulphoxide, carboxyl, nitrosyl, pyridine, thioether or imidazolidine (“Im”) ligand are used.

14. The catalyst system according to claim 13, wherein catalysts of the general formula (B1) in which
M is ruthenium,
X¹ and X² are both chlorine,
R¹ is a straight-chain or branched C₁-C₁₂-alkyl radical,
R², R³, R⁴ and R⁵ are identical or different and are each hydrogen or an organic or inorganic radical, and
L is a phosphine, sulphonated phosphine, phosphate, phosphinite, phosphonite, arsine, stibine, ether, amine, amide, sulphoxide, carboxyl, nitrosyl, pyridine, thioether or imidazolidine (“Im”) ligand
are used.

15. The catalyst system according to claim 13, wherein catalysts of the general formula (B1) in which
M is ruthenium,
X¹ and X² are both chlorine,
R¹ is an isopropyl radical,
R², R³, R⁴, R⁵ are all hydrogen and
L is a substituted or unsubstituted imidazolidine radical of the formula (IIa) or (IIb) 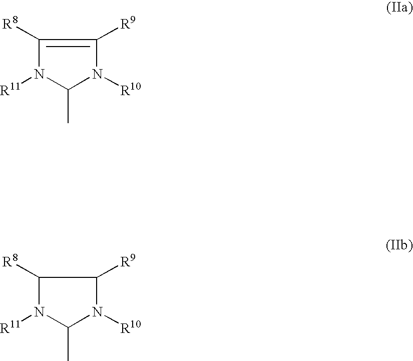
where
R⁸, R⁹, R¹⁰, R¹¹ are identical or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₆-C₂₄-arylthio, C₁-C₂₀-alkylsulphonyl, C₁-C₂₀-alkylsulphonate, C₆-C₂₄-arylsulphonate or C₁-C₂₀-alkylsulphinyl,
are used.

16. The catalyst system according to claim 1, wherein a catalyst of the structure (VII), (VIII), (IX), (X), (XI), (XII), (XIII), (XIV) or (XV) below, where Mes is in each case 2,4,6-trimethylphenyl, is used.

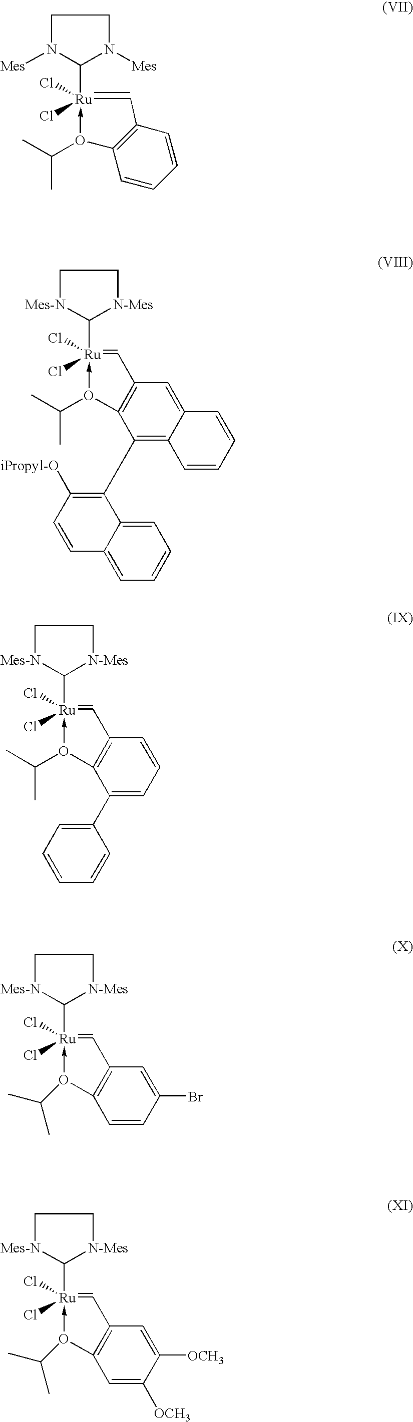

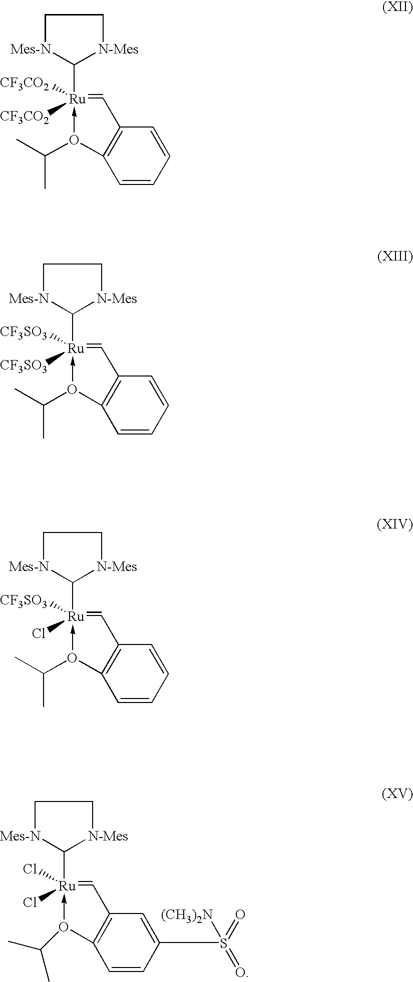

17. The catalyst system according to claim 1, wherein a catalyst of the general formula (B2), 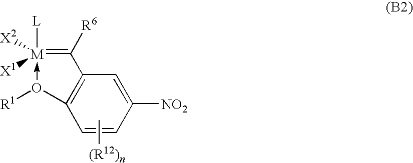
where
M is ruthenium or osmium,
X¹ and X² are identical or different ligands,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical which may in each case optionally be substituted by one or more alkyl, halogen, alkoxy, aryl or heteroaryl radicals,
R⁶ is hydrogen or an alkyl, alkenyl, alkynyl or aryl radical and
L is a phosphine, sulphonated phosphine, phosphate, phosphinite, phosphonite, arsine, stibine, ether, amine, amide, sulphoxide, carboxyl, nitrosyl, pyridine, thioether or imidazolidine (“Im”) ligand and
R¹² are identical or different and are an organic or inorganic radical,
n is 0, 1, 2 or 3,
is used.

18. The catalyst system according to claim 17, wherein a catalyst of the structure (XVI) or (XVII) where Mes is in each case 2,4,6-trimethylphenyl, is used.

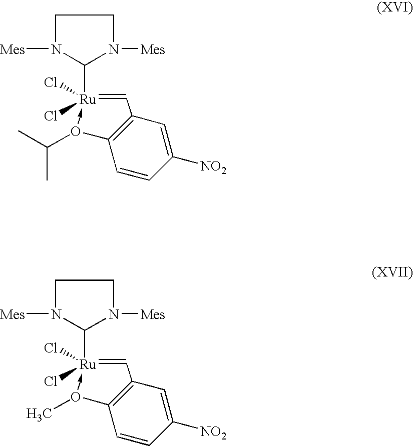

19. The catalyst system according to claim 1, wherein a catalyst of the general formula (B3), 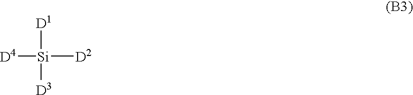
where D¹, D², D³ and D⁴ each have a structure of the general formula (XVIII) shown below which is bound via the methylene group to the silicon of the formula (B3), 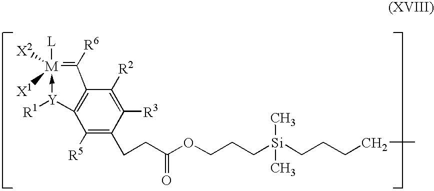
where
M is ruthenium or osmium,
Y is oxygen (O), sulphur (S), an N—R¹ radical or a P—R¹ radical,
X¹ and X² are identical or different ligands,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical which may in each case optionally be substituted by one or more alkyl, halogen, alkoxy, aryl or heteroaryl radicals,
R², R³ and R⁵ are identical or different and are each hydrogen or an organic or inorganic radical,
R⁶ is hydrogen or an alkyl, alkenyl, alkynyl or aryl radical and
L is a phosphine, sulphonated phosphine, phosphate, phosphinite, phosphonite, arsine, stibine, ether, amine, amide, sulphoxide, carboxyl, nitrosyl, pyridine, thioether or imidazolidine (“Im”) ligand.
is used.

20. The catalyst system according to claim 1, wherein a catalyst of the general formula (B4), 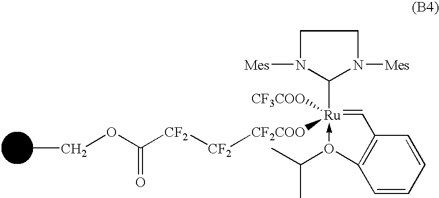
where the symbol 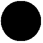
is used.

21. The catalyst system according to claim 1, wherein a catalyst of the general formula (C), 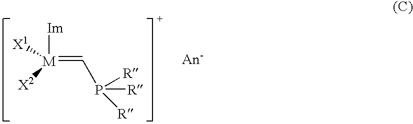
where
M is ruthenium or osmium,
X¹ and X² are identical or different and are anionic ligands,
R″ are identical or different and are organic radicals,
Im is a substituted or unsubstituted imidazolidine radical and
An is an anion,
is used.

22. The catalyst system according to claim 1, wherein a catalyst of the general formula (D), 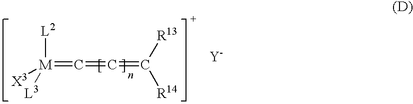
where
M is ruthenium or osmium,
R¹³ and R¹⁴ are each, independently of one another, hydrogen, C₁-C₂₀-alkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀-alkylsulphinyl,
X³ is an anionic ligand,
L² is an uncharged π-bonded ligand which may either be monocyclic or polycyclic,
L³ is a ligand selected from the group consisting of phosphines, sulphonated phosphines, fluorinated phosphines, functionalized phosphines having up to three aminoalkyl, ammonioalkyl, alkoxyalkyl, alkoxycarbonylalkyl, hydrocarbonylalkyl, hydroxyalkyl or ketoalkyl groups, phosphites, phosphinites, phosphonites, phosphinamines, arsines stibines, ethers, amines, amides, imines, sulphoxides, thioethers and pyridines,
Y⁻ is a noncoordinating anion and
n is 0, 1, 2, 3, 4 or 5,
is used.

23. The catalyst system according to claim 1, wherein a catalyst of the general formula (E), 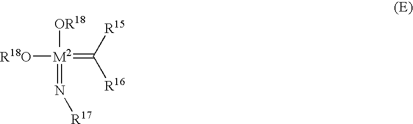
where
M² is molybdenum,
R¹⁵ and R¹⁶ are identical or different and are each hydrogen, C₁-C₂₀-alkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₇₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀-alkylsulphinyl,
R¹⁷ and R¹⁸ are identical or different and are each a substituted or halogen-substituted C₁-C₂₀-alkyl, C₆-C₂₄-aryl, C₆-C₃₀-aralkyl radical or a silicone-containing analogue thereof,
is used.

24. The catalyst system according to claim 1, wherein a catalyst of the general formula (F), 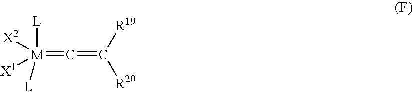
where
M is ruthenium or osmium,
X¹ and X² are identical or different and are anionic ligands,
the symbols L represent identical or different ligands, and
R¹⁹ and R²⁰ are identical or different and are each hydrogen or substituted or unsubstituted alkyl,
is used.

25. The catalyst system according to claim 1, wherein a catalyst of the general formula (G), (H) or (K), 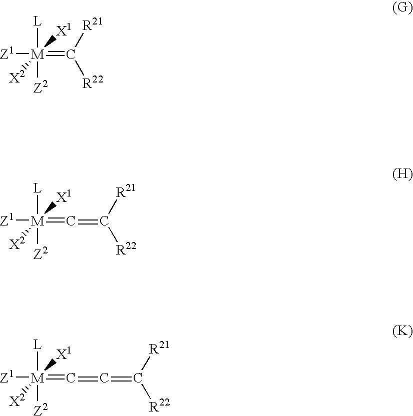
where
M is osmium or ruthenium,
X¹ and X² are identical or different and are two ligands, preferably anionic ligands,
L is a ligand, preferably an uncharged electron donor,
Z¹ and Z² are identical or different and are uncharged electron donors,
R²¹ and R²² are each, independently of one another, hydrogen alkyl, cycloalkyl, alkenyl, alkynyl, aryl, carboxylate, alkoxy, alkenyloxy, alkynyloxy, aryloxy, alkoxycarbonyl, alkylamino, alkylthio, alkylsulphonyl or alkylsulphinyl which may in each case optionally be substituted by one or more radicals selected from among alkyl, halogen, alkoxy, aryl or heteroaryl,
is used.

26. The catalyst system according to claim 1 which comprises at least one compound of the general formula (Z) and a catalyst (N) which has the general structural element (N1), where the carbon atom denoted by “*” is bound via one or more double bonds to the catalyst framework, 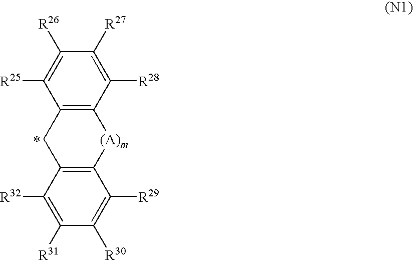
and where
R²⁵-R³² are identical or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃⁻), —OSO₃⁻, —PO₃⁻ or OPO₃⁻ or alkyl, cycloalkyl, alkenyl, alkynyl, aryl, carboxylate, alkoxy, alkenyloxy, alkynyloxy, aryloxy, alkoxycarbonyl, alkylamino, alkylthio, arylthio, alkylsulphonyl, alkylsulphinyl, dialkylamino, alkylsilyl or alkoxysilyl, where these radicals can each optionally be substituted by one or more alkyl, halogen, alkoxy, aryl or heteroaryl radicals, or, as an alternative, two directly adjacent radicals from the group consisting of R²⁵-R³² together with the ring carbons to which they are bound form a cyclic group, preferably an aromatic system, by bridging or, as an alternative, R⁸ is optionally bridged to another ligand of the ruthenium- or osmium-carbene complex catalyst,
m is 0 or 1 and
A is oxygen, sulphur, C(R³³R³⁴), N—R³⁵, —C(R³⁶)═C(R³⁷)—, —C(R³⁶)(R³⁸)—C(R³⁷)(R³⁹)—, where R³³-R³⁹ are identical or different and can each have the same meanings as the radicals R²⁵-R³².

27. The catalyst system according to claim 1, wherein a compound of the general formula (Z) is used, in which the radicals R are identical and are either selected from the group consisting of methyl, ethyl, n-propyl, i-propyl, n-butyl, i-butyl, tert-butyl, n-pentyl, i-pentyl, tert-pentyl, hexyl, octyl, decyl, dodecyl, hexadecyl, octadecyl, 1-isopropyl-2-methylpropyl, 2,2,2-trifluoroethyl, 2-cyclohexylcyclohexyl, 2-ethylhexyl, 3,3,5-trimethylhexyl, 1-ethynylcyclohexyl, 1-isobutyl-3-methylbutyl, allyl, methallyl, oleyl, phenyl, benzyl, o-tolyl and sterically hindered phenyl.

28. The catalyst system according to claim 1, wherein the complex catalyst and the compound of the general formula (Z) are used in a molar ratio of [complex catalyst:compound of the general formula (Z)]=1:(0.1-1000).

29. The catalyst system according to claim 1, wherein the complex catalyst and the compound of the general formula (Z) are used in a molar ratio of [complex catalyst:compound of the general formula (Z)]=1:(0.5-100).

30. The catalyst system according to claim 1, wherein the complex catalyst and the compound of the general formula (Z) are used in a molar ratio of [complex catalyst:compound of the general formula (Z)]=1:(1-50).

31. A method of using the catalyst system according to claim 1 comprising subjecting one or more starting molecules to a metathesis reaction in the presence of a catalyst system according to claim 1, preferably to a ring-closing metatheses (RCM), cross metatheses (CM) or a ring-opening methatheses (ROMP).

32. The method according to claim 31 comprising contacting a nitrile rubber containing repeating units derived from at least one conjugated diene, at least one α,β-unsaturated nitrile and optionally one or more further copolymerizable monomers, optionally in the presence of a coolefin, with the catalyst system according to claim 1.

33. The method according to claim 32, wherein the compound of the general formula (Z) is added in a solvent or dispersant or alternatively without a solvent or dispersant to the complex catalyst or a solution of the complex catalyst.

34. The method according to claim 33, wherein the amount of the complex catalyst present in the catalyst system is from 1 to 1000 ppm of noble metal, based on the nitrile rubber used.

35. The method according to claim 34, wherein the amount of the complex catalyst present in the catalyst system is from 2 to 500 ppm, based on the nitrile rubber used.

36. The method according to claim 35, wherein the amount of the complex catalyst present in the catalyst system is from 5 to 250 ppm, based on the nitrile rubber used.

37. A method of using a compound of the general formula (Z)
B(OR′)₃
where the radicals R′ are identical or different and are alkyl, cycloalkyl, alkenyl, allyl, alkynyl, aryl or heteroaryl radicals, where the heteroaryl radicals have at least one heteroatom, preferably nitrogen or oxygen, or R′ is a radical of the general formula (—CHZ¹—CHZ¹-A²-)ₚ—CH₂—CH₃, where p is an integer from 1 to 10, the radicals Z¹ are identical or different and are each hydrogen or methyl, with the radicals Z¹ located on adjacent carbon atoms preferably being different, and A² is oxygen, sulphur or —NH, or else two or three radicals R′ can be bridged to one another
as a constituent of catalyst systems also containing a complex catalyst for metathesis comprising contacting the compound of general formula (Z) with the complex catalyst.

38. A process for reducing the molecular weight of a nitrile rubber, wherein a copolymer or terpolymer containing repeating units of at least one conjugated diene, at least one α,β-unsaturated nitrile and optionally one or more further copolymerizable monomers is used as nitrile rubber and the nitrile rubber is, if appropriate in the presence of a coolefin, brought into contact with the catalyst system according to claim 1.
